(19) United States
(12) Patent Application Publication
(10) Pub. No.: US 2018/0102911 A1
(43) Pub. Date: Apr. 12, 2018

(54) COMMUNICATION APPARATUS AND METHOD

(71) Applicant: FUJITSU LIMITED, Kawasaki-shi (JP)

(72) Inventor: Yuji Kojima, Kawasaki (JP)

(73) Assignee: FUJITSU LIMITED, Kawasaki-shi (JP)

(21) Appl. No.: 15/713,079

(22) Filed: Sep. 22, 2017

(30) Foreign Application Priority Data
Oct. 12, 2016 (JP) 2016-200875

(51) Int. Cl. H04L 12/18; H04L 12/761; H04L 12/715

(52) U.S. Cl. CPC H04L 12/185; H04L 45/16; H04L 63/065; H04L 12/18; H04L 45/04

(57) ABSTRACT

A disclosed communication method includes: transferring, to a first apparatus, one request packet of plural request packets for first content, upon receiving the plural request packets from a second apparatus; identifying a first multicast address that is allocated to the first content; transmitting, to the first apparatus and the second apparatus, identification information of the first content and the first multicast address; and transferring, to the second apparatus, the first content by the first multicast address, upon receiving the first content from the first apparatus.

### CROSS-REFERENCE TO RELATED APPLICATIONS

This application is based upon and claims the benefit of priority of the prior Japanese Patent Application No. 2016-200875, filed on Oct. 12, 2016, the entire contents of which are incorporated herein by reference.

### FIELD

This invention relates to a technique for transferring data in a network.

### BACKGROUND

The Internet was originally designed for transmitting and receiving end-to-end data, but recently the Internet has been used as a delivery system for content (for example, videos, music, or the like) from a server to terminals. Therefore, researches on ICN (Information Centric Networking), which is a network technique focusing on information delivery, are actively conducted. ICN is also referred to as CCN (Content Centric Networking) or NDN (Named Data Networking).

As for ICN, a certain document discloses the following techniques. Specifically, each of plural nodes that transfer a packet with an identifier of content transfers a request packet for the content by using at least one of plural multicast trees, and receives a response packet that includes the requested content as a response to the request packet. As a result, an increase in the network load is suppressed.

However, there is a case where a network in which ICN communication occurs includes not only nodes compliant with the ICN communication, but also nodes noncompliant with the ICN communication. Then, this causes a case where bandwidth is not efficiently used for transferring content. The aforementioned technique does not focus on such a problem. In other words, there is no technique to efficiently use bandwidth in a network in which content is transferred.
Patent Document 1: International Publication Pamphlet No. WO 2015/029321

### SUMMARY

A disclosed communication method relating to one aspect includes: transferring, to a first apparatus, one request packet of plural request packets for first content, upon receiving the plural request packets from a second apparatus; identifying a first multicast address that is allocated to the first content; transmitting, to the first apparatus and the second apparatus, identification information of the first content and the first multicast address; and transferring, to the second apparatus, the first content by the first multicast address, upon receiving the first content from the first apparatus.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram for explaining content transfer using ICN;

FIG. 2 is a diagram for explaining content transfer using ICN;

FIG. 3 is a diagram for explaining transfer of a request packet using ICN;

FIG. 4 is a diagram for explaining content transfer using ICN;

FIG. 5 is a diagram depicting a network configuration;

FIG. 6 is a functional block diagram of an ICN node;

FIG. 7 is a functional block diagram of a terminal;

FIG. 8 is a diagram for explaining an outline of a first embodiment;

FIG. 9 is a diagram for explaining an outline of the first embodiment;

FIG. 10 is a diagram for explaining an outline of the first embodiment;

FIG. 11 is a sequence diagram for processing executed in the first embodiment;

FIG. 12 is a sequence diagram for processing executed in the first embodiment;

FIG. 13 is a diagram for explaining multicast tree join processing;

FIG. 14 is a diagram for explaining the multicast tree join processing;

FIG. 15 is a diagram for explaining the multicast tree join processing;

FIG. 16 is a diagram for explaining the multicast tree join processing;

FIG. 17 is a diagram for explaining the multicast tree join processing;

FIG. 18 is a diagram for explaining the multicast tree join processing;

FIG. 19 is a diagram for explaining an outline of a second embodiment;

FIG. 20 is a diagram for explaining an outline of the second embodiment;

FIG. 21 is a sequence diagram for processing executed in the second embodiment;

FIG. 22 is a diagram for explaining an outline of a third embodiment;

FIG. 23 is a diagram for explaining an outline of the third embodiment;

FIG. 24 is a sequence diagram for processing executed in the third embodiment;

FIG. 25 is a sequence diagram for processing executed in the third embodiment;

FIG. 26 is a diagram for explaining allocation of multicast addresses;

FIG. 27 is a diagram for explaining an outline of a fourth embodiment;

FIG. 28 is a diagram for explaining an outline of the fourth embodiment;

FIG. 29 is a sequence diagram for processing executed in the fourth embodiment;

FIG. 30 is a sequence diagram for processing executed in the fourth embodiment;

FIG. 31 is a sequence diagram for processing executed in the fourth embodiment;

FIG. 32 is a functional block diagram of a relay apparatus; and

FIG. 33 is a functional block diagram of a computer.

### DESCRIPTION OF EMBODIMENTS

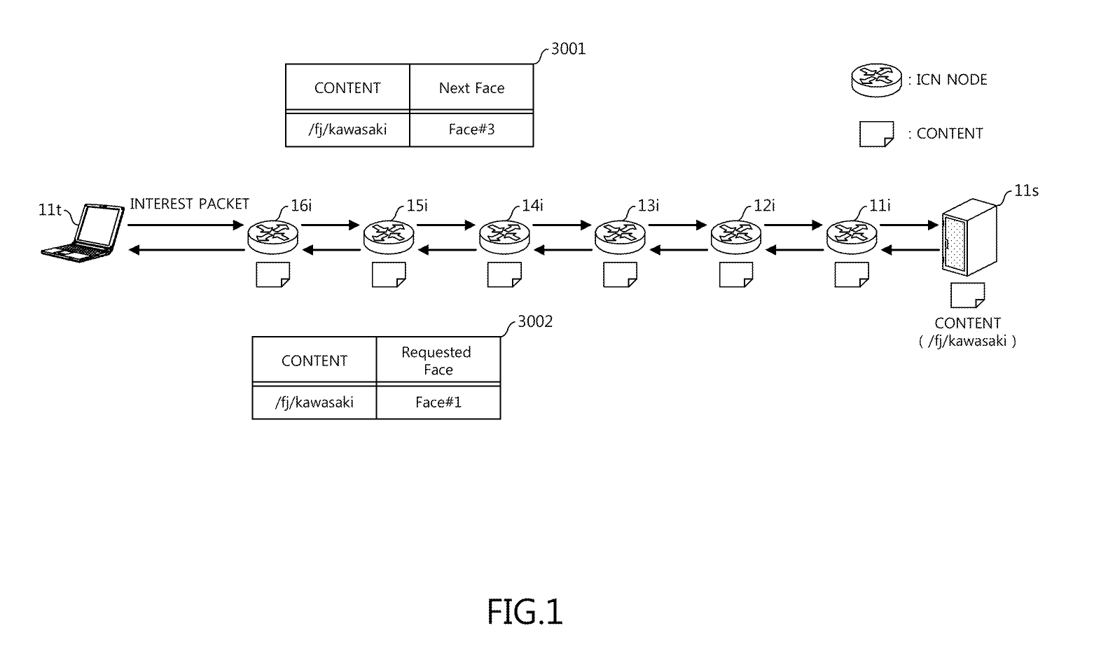

Firstly, content transfer using ICN will be briefly explained with reference to FIGS. 1 to 4. For example, as illustrated in FIG. 1, a terminal 11t transmits an interest packet that includes a content ID (IDentification information) of requested content. The interest packet is also referred to as a request packet. In FIG. 1, “/fj/kawasaki” is the content ID. The terminal 11t only has to be compliant to ICN (hereinafter, referred to as an ICN node) and to send an interest packet to a node located at a connection point to a network. Therefore, it is unnecessary to find a server for each content and to perform end-to-end communication with the server. Incidentally, a content name may be used instead of the content ID.

Each ICN node identifies a face (that is, an interface in ICN. Here, “Next Face”) that corresponds to the content ID included in the interest packet from a FIB (Forwarding Information Base) 3001, and transfers the interest packet through the identified face. The FIB 3001 is generated in advance in each ICN node by advertising a content name by a content server 11s. In addition, each ICN node registers information of a face that received the interest packet in a PIT (Pending Interest Table) 3002.

The interest packet is transferred via a route that passes through an ICN node 16i, an ICN node 15i, an ICN node 14i, an ICN node 13i, an ICN node 12i and an ICN node 11i, and reaches the content server 11s. The content server 11s transmits content that has the content ID included in the interest packet to the ICN node 11i.

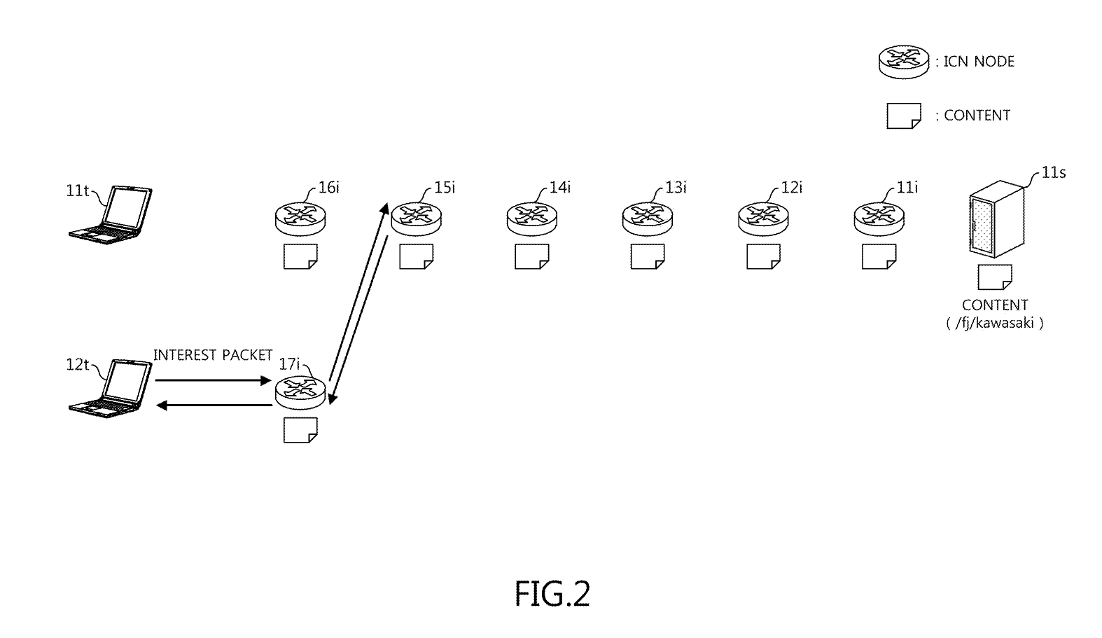

The content is transferred via a route that passes through the ICN node 11i, the ICN node 12i, the ICN node 13i, the ICN node 14i, the ICN node 15i and the ICN node 16i, and reaches the terminal 11t. Here, each ICN node identifies, from the PIT 3002, a face (here, “Requested Face”) that corresponds to the content ID of the transferred content, and transfers the content through the identified face. In addition, each ICN node stores a cache of the content according to a cache algorithm. In the following embodiments, “cache” mainly means data that is stored in a cache memory as a copy of the content. From then on, as illustrated in FIG. 2, for example, another terminal 12t that requests the content can obtain the content from the cache.

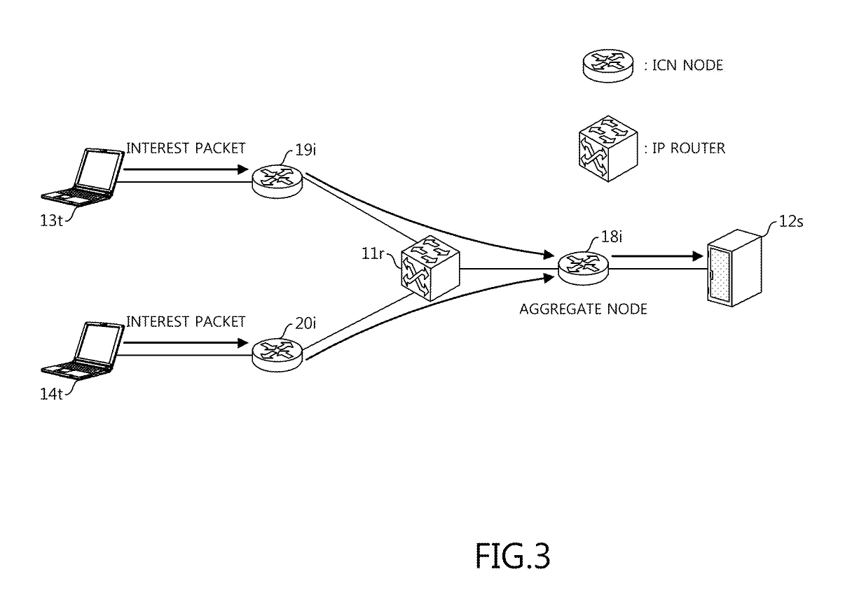

In a network where the ICN communication occurs, not all relay nodes are necessarily ICN nodes, and the network is expanded in an overlay structure on an existing IP (Internet Protocol)/L3 (Layer 3) network (ICN Over IP). For example, in FIG. 3, an IP router 11r does not perform the ICN communication. Not end-to-end communication between content server 12s and terminals 13t and 14t but hop-by-hop communication between ICN nodes occurs. Hop-by-hop communication between ICN nodes is performed by using IP unicast. In the following, “unicast” means IP unicast.

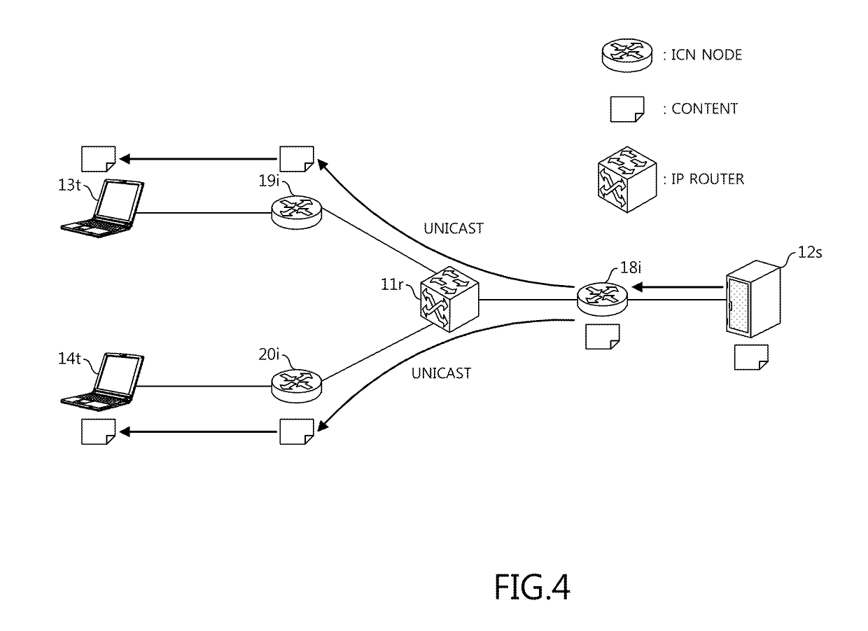

As illustrated in FIG. 3, an ICN node 18i (referred to as an aggregate node) that received an interest packet including the same content ID from plural routes aggregates plural interest packets into one interest packet and sends it to the content server 12s. As illustrated in FIG. 4, when the ICN node 18i which is the aggregate node receives content, the ICN node 18i generates a copy of the content and transfers the content to the terminal 13t and the terminal 14t by plural times of unicast communication. Although two times of unicast communication occurs between the IP router 11r and the ICN node 18i, there is no problem for this section between the IP router 11r and the ICN node 18i even if multicast communication occurs once. And two times of unicast communication makes the bandwidth to be consumed wastefully.

Therefore, in the following, a method of transferring content so as to efficiently use the bandwidth will be explained.

### Embodiment 1

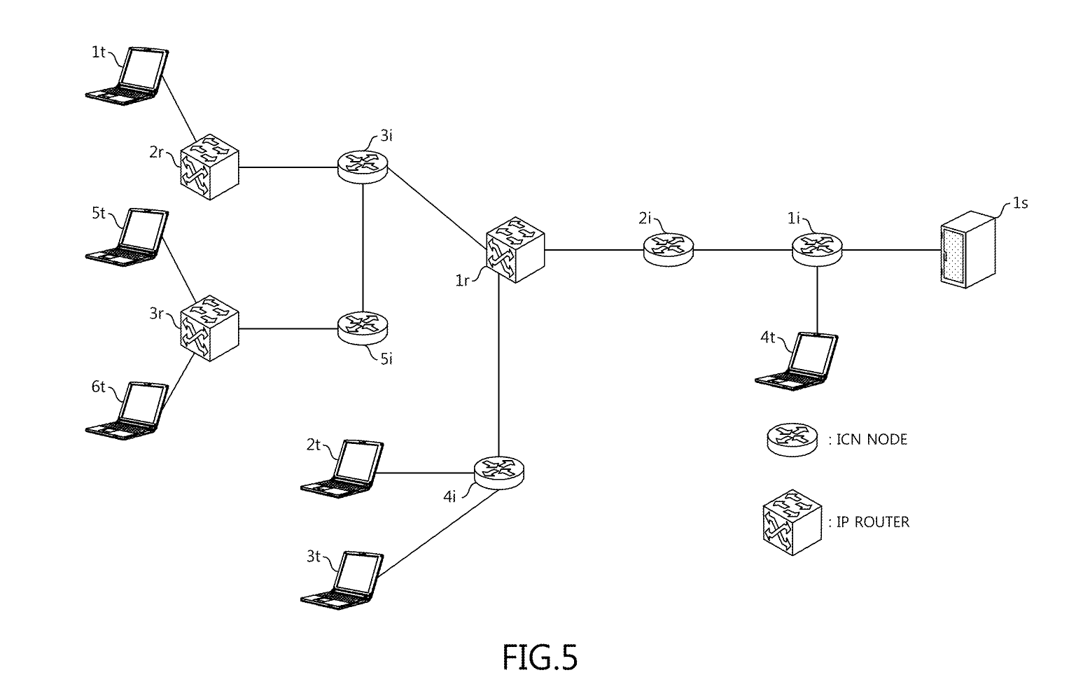

FIG. 5 illustrates a network configuration of a first embodiment. A content server 1s delivers content to terminals that request the content (for example, videos, sound or the like) by the ICN communication. ICN nodes 1i to and IP routers 1r to 3r are arranged in a network. Terminals 1t to 6t such as personal computers or smart phones are connected to a relay node at a connection point to the network. More specifically, the ICN node 1i is connected to the content server 1s and the terminal 4t, the ICN node 2i is connected to the ICN node 1i, and the IP router 1r is connected to the ICN node 2i. The ICN node 4i is connected to the IP router 1r, and the terminals 2t and 3t are connected to the ICN node 4i. The ICN node 3i is connected to the IP router 1r, and the IP router 2r and the ICN node 5i are connected to the ICN node 3i. The terminal 1t is connected to the IP router 2r. The IP router 3r is connected to the ICN node 5i, and the terminals 5t and 6t are connected to the IP router 3r. The connections among apparatuses may be wire or wireless connections.

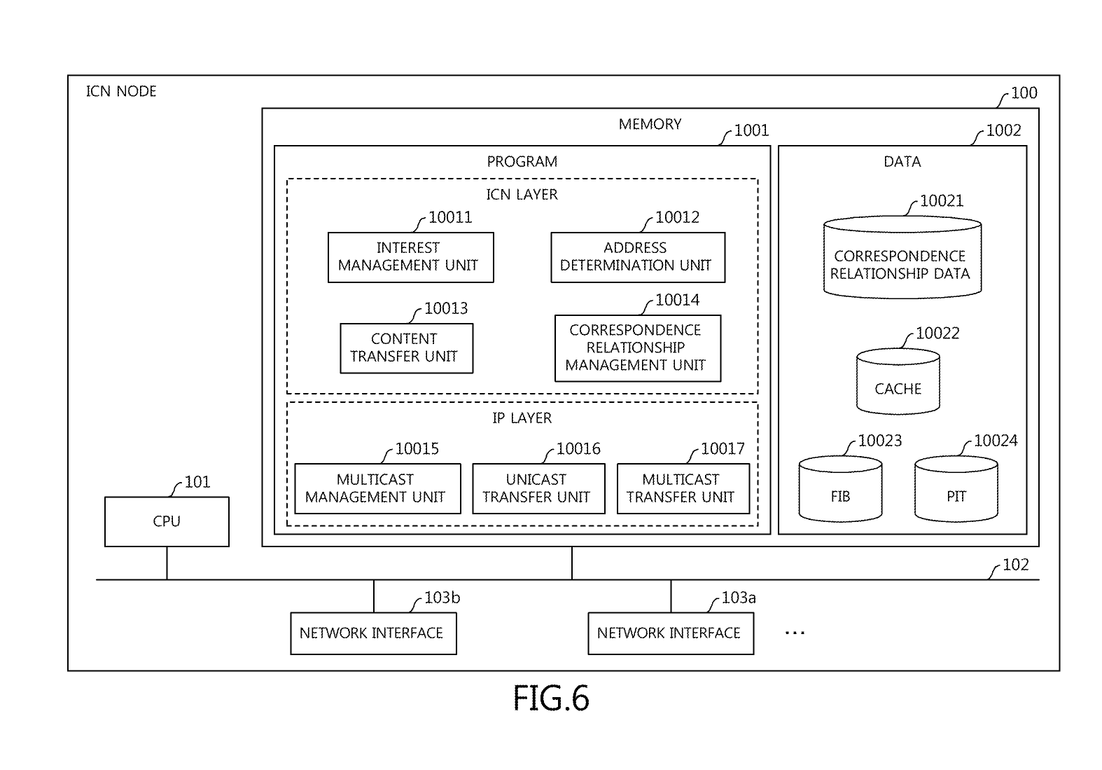

FIG. 6 illustrates a functional block diagram of each ICN node. Each ICN node includes a memory 100 such as a RAM (Random Access Memory), a CPU (Central Processing Unit) 101, a bus 102 for mutually connecting hardware components, and network interfaces 103a and 103b that are hardware. The network interfaces 103a and 103b are, for example, interfaces for Ethernet (registered trademark) or interfaces for a wireless LAN (Local Area Network). In FIG. 6, the number of network interfaces is two, but the number is not limited.

Program 1001 is, by the CPU 101, loaded into the memory 100 and executed, and realizes plural types of functions illustrated in FIG. 6. Specifically, as functions of an ICN layer, an interest management unit 10011, an address determination unit 10012, a content transfer unit 10013, and a correspondence relationship management unit 10014 are realized. And, as functions of an IP layer, a multicast management unit 10015, a unicast transfer unit 10016 and a multicast transfer unit 10017 are realized. Data 1002 used for processing based on the program 1001 includes correspondence relationship data 10021, content cache 10022, FIB 10023, and PIT 10024. In this embodiment, “multicast” means IP multicast.

The interest management unit 10011 generates and transfers an interest packet. The address determination unit 10012 determines a multicast address that corresponds to the received content. The content transfer unit 10013 transfers, by the ICN communication, the content that has been transmitted by the content server 1s. The correspondence relationship management unit 10014 manages a correspondence relationship between content and multicast addresses. The multicast management unit 10015 executes processing such as processing to join in a multicast tree. The unicast transfer unit 10016 transfers data by IP unicast communication. The multicast transfer unit 10017 transfers data by multicast communication.

The correspondence relationship data 10021 includes data that represents a correspondence relationship between a content ID and a multicast address. The cache 10022 includes a cache of content. As described above, the FIB 10023 stores a content ID in association with a face through which an interest packet is outputted. As described above, the PIT 10024 stores a content ID in association with a face that has received an interest packet.

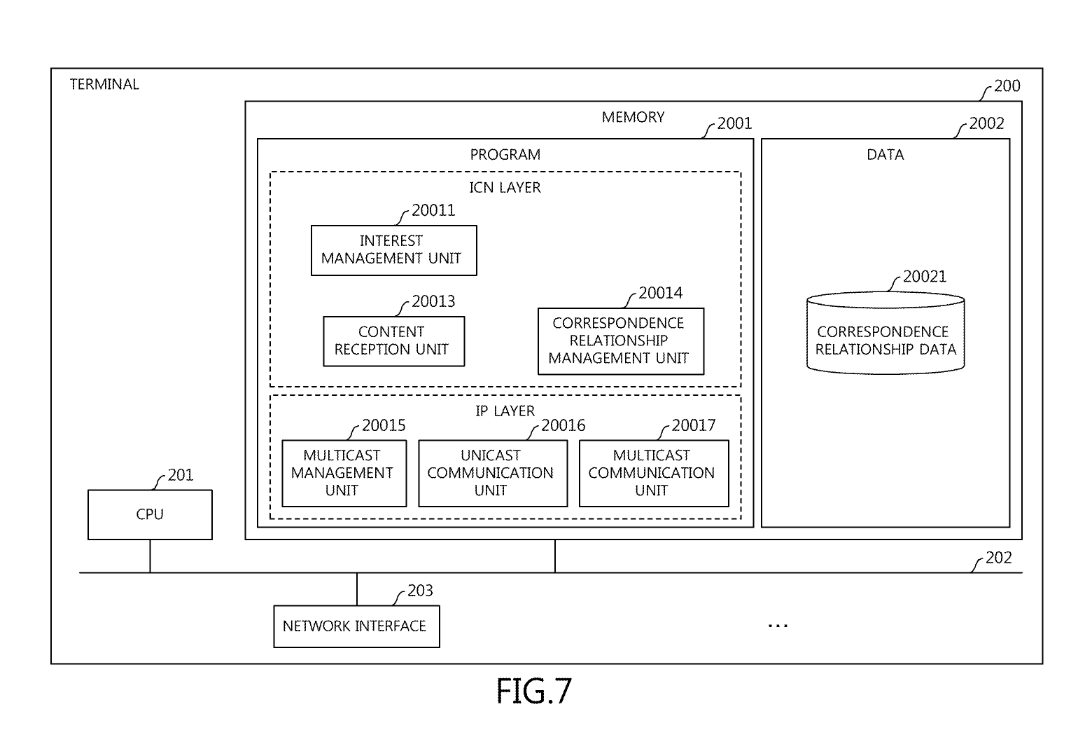

FIG. 7 illustrates a functional block diagram of each terminal. Each terminal has, for example, a memory 200 such as a RAM, a CPU 201, a bus 202 for mutually connecting hardware components, and a network interface 203 that are hardware. The network interface 203 is, for example, an interface for Ethernet (registered trademark) or an interface for a wireless LAN.

The program 2001 is, by the CPU 201, loaded into the memory 200 and executed, and realizes plural types of functions illustrated in FIG. 7. Specifically, as functions of the ICN layer, an interest management unit 20011, a content reception unit 20013, and a correspondence relationship management unit 20014 are realized. And, as functions of the IP layer, a multicast management unit 20015, a unicast communication unit 20016, and a multicast communication unit 20017 are realized. The data 2002 used for processing based on the program 2001 includes correspondence relationship data 20021.

The interest management unit 20011 generates and transmits an interest packet. The content reception unit 20013 receives the content transmitted by the content server 1s. The correspondence relationship management unit 20014 manages a correspondence relationship between content and multicast addresses. The multicast management unit 20015 executes processing such as processing to issue an IGMP (Internet Group Management Protocol) Join message. The unicast communication unit 20016 transmits and receives data by unicast communication. The multicast communication unit 20017 receives content transmitted by multicast communication.

The correspondence relationship data 20021 includes data representing a correspondence relationship between a content ID and multicast address.

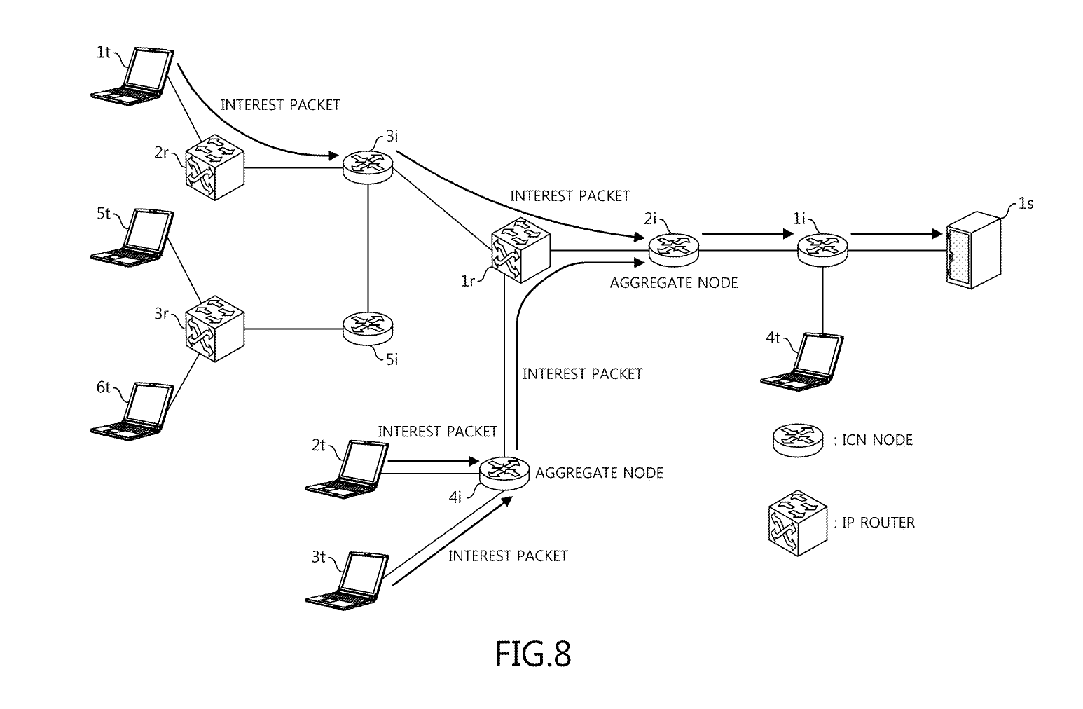

An outline of the first embodiment will be explained with reference to FIGS. 8 to 10. For example, as illustrated in FIG. 8, it is assumed that the terminal 1t, terminal 2t and terminal 3t transmit interest packets that include the same content ID. In FIG. 8, the ICN node 2i and the ICN node 4i correspond to aggregate nodes, three interest packets are aggregated, and eventually one interest packet reaches the content server 1s.

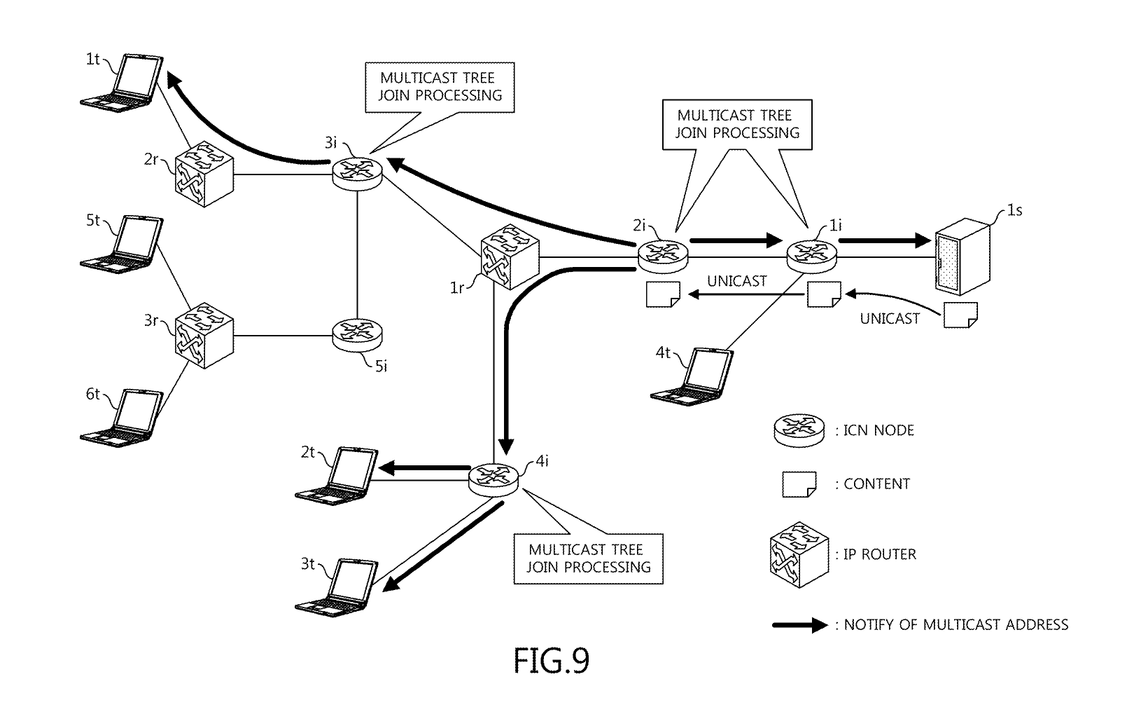

As illustrated in FIG. 9, when the content server 1s receives the interest packet, the content server 1s transmits content that has the content ID included in the interest packet to ICN node 1i by unicast. Since the ICN node 2i that received the transmitted content is an aggregate node, the ICN node 2i determines a multicast address that corresponds to the received content. Then, when it is assumed that a direction toward the content server 1s that is a transfer destination of the interest packet is a forward direction, the ICN node 2i transmits, to the ICN node 3i and the ICN node 4i that correspond to previous-hop relay nodes in an inverse direction and the ICN node 1i that corresponds to a next-hop relay node, correspondence relationship data that includes the received content and a multicast address that corresponds to the received content. The correspondence relationship data arrives at the ICN node 1i, the content server 1s, the ICN node 3i, terminal 1t, the ICN node 4i, the terminal 2t and the terminal 3t. Each of the ICN nodes that received the correspondence relationship data executes processing (hereinafter, referred to as multicast tree join processing) to join a multicast tree (also referred to as a multicast delivery tree) according to a multicast routing protocol (PIM-SM (Protocol-Independent Multicast-Sparse Mode) or PIM-DM (Protocol-Independent Multicast-Dense Mode)). In PIM-SM, a Join message is sent to a relay node which is a rendezvous point (RP: Rendezvous Point), and thereby joining the multicast tree is expressed. In PIM-DM, joining the multicast tree is expressed by preventing transmission of prune messages. In addition, each terminal that received the correspondence relationship data transmits an IGMP Join message, and thereby joining the multicast tree is expressed.

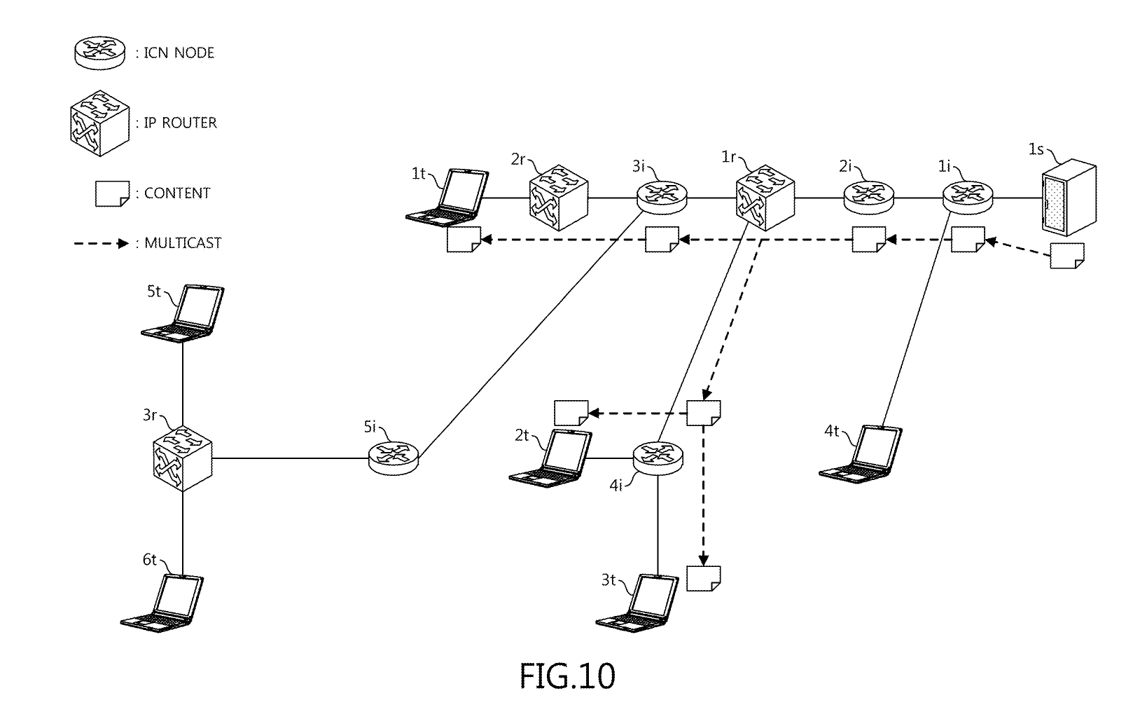

As a result, as illustrated in FIG. 10, content is delivered to the terminal 1t, the terminal 2t, and the terminal 3t by multicast. Here, between the ICN node 2i and the IP router 1r, multicast communication occurs once instead of two times of unicast communication. Therefore, it is possible to efficiently use the bandwidth between the ICN node 2i and the IP router 1r.

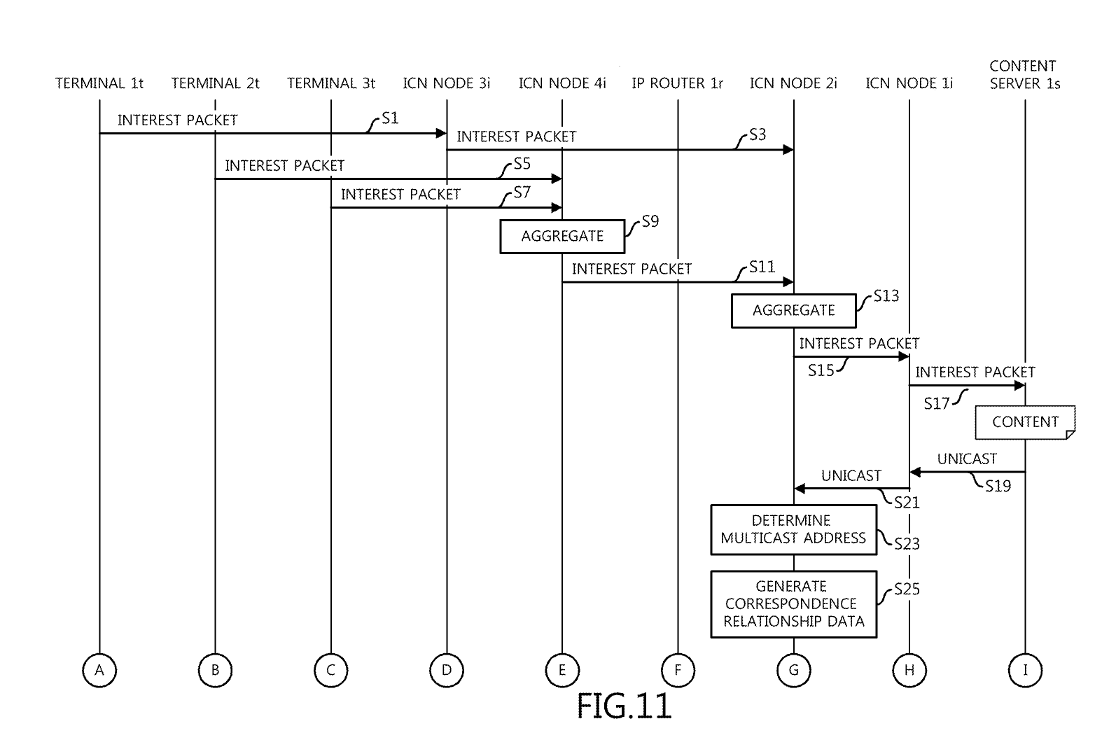

Next, with reference to FIGS. 11 to 18, the first embodiment will be explained in more detail.

First, the interest management unit 20011 of the terminal 1t transmits an interest packet that includes a content ID to the ICN node 3i (FIG. 11: step S1).

The ICN node 3i transfers the interest packet received from the terminal 1t to the ICN node 2i (step S3).

The interest management unit 20011 of the terminal 2t transmits an interest packet that includes the same content ID as the content ID transmitted by the terminal 1t to the ICN node 4i (step S5).

The interest management unit 20011 of the terminal 3t transmits an interest packet that includes the same content ID as the content ID transmitted by the terminal 1t to the ICN node 4i (step S7).

The interest management unit 10011 of the ICN node 4i aggregates the interest packet received from the terminal 2t and the interest packet received from the terminal 3t (step S9). The aggregation is processing to aggregate plural interest packets into one interest packet. Then, the interest management unit 10011 of the ICN node 4i transfers one interest packet to the ICN node 2i (step S11). In step S11, a transfer destination is determined according to information stored in the FIB 10023. In addition, identification information of a face that received the interest packet is registered in the PIT 10024 in association with the content ID included in the interest packet. The same applies to the aforementioned step S3 and the following.

Incidentally, whether or not to execute the aggregation is determined depending on whether or not plural “Requested Face” for the same content ID is registered in the PIT 10024. This determination is made by the interest management unit 10011. The same applies to the following.

The interest management unit 10011 of the ICN node 2i receives interest packets from the ICN node 3i and the ICN node 4i. Then, the interest management unit 10011 of the ICN node 2i aggregates the two received interest packets (step S13), and transfers one interest packet to the ICN node 1i (step S15).

The interest management unit 10011 of the ICN node 1i transfers the interest packet received from the ICN node 2i to the content server is (step S17).

The content server 1s receives the interest packet from the ICN node 1i and reads out content that correspond to the content ID included in the received interest packet from a storage device, for example. Then, the content server 1s transmits the content to the ICN node 1i by unicast (step S19).

The content transfer unit 10013 of the ICN node 1i transfers the content received from the content server 1s to the ICN node 2i by unicast (namely, by using the unicast transfer unit 10016) (step S21). Moreover, the content transfer unit 10013 stores a cache of the content in the memory 100. When transferring the content, the face of the transfer destination is determined by referring to PIT 10024. The same applies to the following.

The content transfer unit 10013 of the ICN node 2i receives the content from the ICN node 1i and stores a cache of the content in the memory 100. Since the ICN node 2i is an aggregate node and correspondence relationship data for the received content is not stored in the memory 100, it is determined that processing to determine an address is to be executed. Therefore, the address determination unit 10012 determines a multicast address that corresponds to the received content (step S23). For example, the multicast address is determined based on a hash function by using an ID of the ICN node and information of time at the processing of step S23 as input.

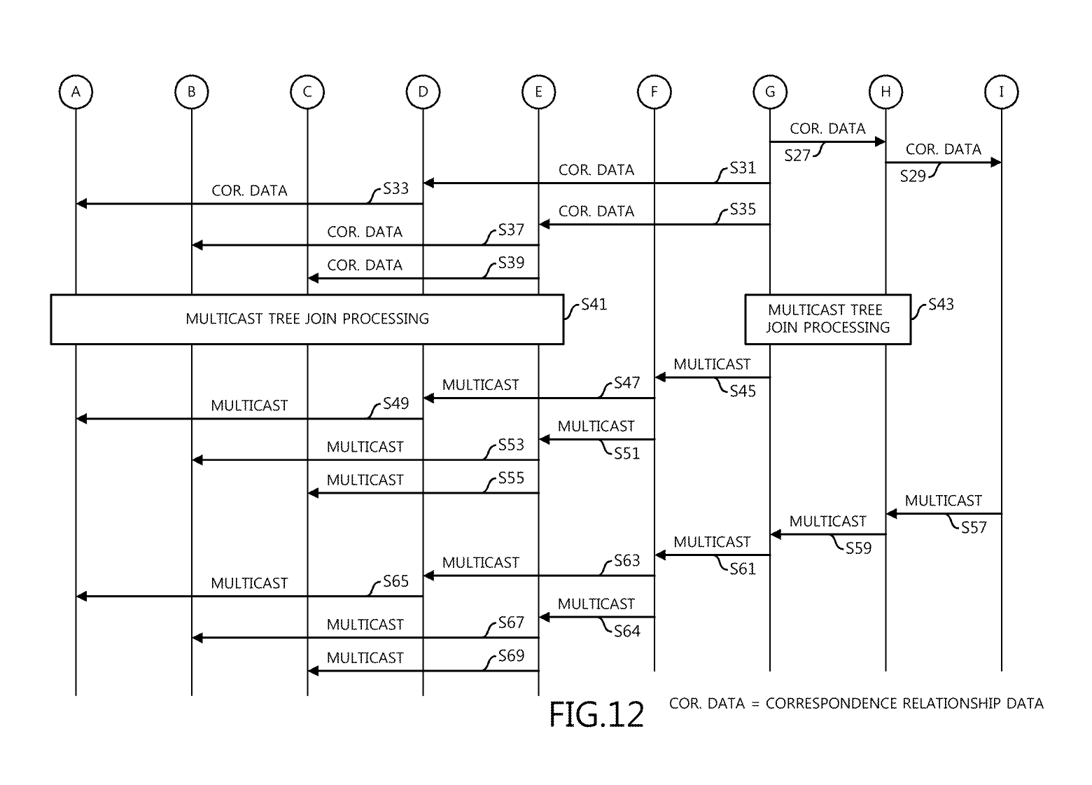

Then, the correspondence relationship management unit 10014 of the ICN node 2i generates correspondence relationship data that represents a correspondence relationship between the received content and the multicast address (step S25). In addition, the correspondence relationship management unit 10014 stores the generated correspondence relationship data in the memory 100. The processing shifts to step S27 of FIG. 12 via terminals A to I.

Shifting to an explanation of FIG. 12, the correspondence relationship management unit 10014 of the ICN node 2i transmits the generated correspondence relationship data to the ICN node 1i that corresponds to a next-hop relay node, when it is assumed that a direction towards the content server 1s is a forward direction (step S27).

The correspondence relationship management unit 10014 of the ICN node 1i transfers the correspondence relationship data received from the ICN node 2i to the content server 1s (step S29). In addition, the correspondence relationship management unit 10014 stores the received correspondence relationship data in the memory 100.

The correspondence relationship management unit 10014 of the ICN node 2i transmits the generated correspondence relationship data to the ICN nodes 3i and 4i that correspond to previous-hop relay nodes which is an inverse, when it is assumed that a direction towards content server 1s is a forward direction (steps S31 and S35).

The correspondence relationship management unit 10014 of the ICN node 3i transfers the correspondence relationship data received from the ICN node 2i to the terminal 1t (step S33). In addition, the correspondence relationship management unit 10014 stores the generated correspondence relationship data in the memory 100.

The correspondence relationship management unit 20014 of the terminal 1t receives the correspondence relationship data from the ICN node 3i and stores the received correspondence relationship data in the memory 200.

The correspondence relationship management unit 10014 of the ICN node 4i transmits the correspondence relationship data received from the ICN node 2i to the terminal 2t and the terminal 3t (steps S37 and S39). In addition, the correspondence relationship management unit 10014 stores the generated correspondence relationship data in the memory 100.

The correspondence relationship management unit 20014 of the terminal 2t receives the correspondence relationship data from the ICN node 4i and stores the received correspondence relationship data in the memory 200. The correspondence relationship management unit 20014 of the terminal 3t receives the correspondence relationship data from the ICN node 4i and stores the received correspondence relationship data in the memory 200.

The multicast management unit 20015 of the terminal 1t, the terminal 2t and the terminal 3t, and the multicast management unit 10015 of the ICN node 3i and the ICN node 4i execute the multicast tree join processing based on the multicast address allocated to the target content (step S41). In addition, the ICN node 1i and the ICN node 2i execute the multicast tree join processing based on the multicast address allocated to the target content (step S43). The multicast tree join processing will be described later.

In response to this, the content transfer unit 10013 of the ICN node 2i transmits the content received from the ICN node 1i to the IP router 1r by multicast (namely, by using the multicast transfer unit 10017) (step S45).

The IP router 1r copies the content received from the ICN node 2i and transmits the content to the ICN node 3i and the ICN node 4i by multicast (steps S47 and S51).

The content transfer unit 10013 of the ICN node 3i receives the content from the IP router 1r and stores the cache of the content in the memory 100. Then, the content transfer unit 10013 transfers the received content to the terminal 1t by multicast (step S49).

The content transfer unit 10013 of the ICN node 4i receives the content from the IP router 1r and stores a cache of the content in the memory 100. Although the ICN node 4i is an aggregate node, since correspondence relationship data for the received content is stored in the memory 100, it is determined that the processing to determine an address is not to be executed. Then, the content transfer unit 10013 transfers the received content to the terminal 2t and the terminal 3t by multicast (step S53 and step S55).

As described above, the ICN node 2i initially transfers, by multicast, content received by unicast, and subsequently transfers, by multicast, content received by multicast. Depending on a relationship between a timing of transmitting correspondence relationship data to the content server 1s and a timing in which the content server 1s transmits content, also the ICN node 1i initially transfers, by multicast, content received by unicast, and subsequently transfers, by multicast, content received by multicast.

When the live content is delivered, the content server 1s further delivers the content by multicast (step S57).

The content transfer unit 10013 of the ICN node 1i receives the content from the content server 1s and stores a cache of the content in the memory 100. Then, the content transfer unit 10013 transmits the received content to the ICN node 2i by multicast (step S59).

The content transfer unit 10013 of the ICN node 2i receives the content from the ICN node 1i and stores a cache of the content in the memory 100. Then, the content transfer unit 10013 transmits the received content to the IP router 1r by multicast (step S61).

The IP router 1r copies the content received from the ICN node 2i and transmits, by multicast, the content to the ICN node 3i and the ICN node 4i (steps S63 and S64).

The content transfer unit 10013 of the ICN node 3i receives the content from the IP router 1r and stores a cache of the content in the memory 100. Then, the content transfer unit 10013 transfers the received content to the terminal 1t by multicast (step S65).

The content transfer unit 10013 of the ICN node 4i receives the content from the IP router 1r and stores a cache of the content in the memory 100. Then, the content transfer unit 10013 transfers the received content to the terminal 2t and the terminal 3t by multicast (step S67 and step S69).

By using multicast as described above, it becomes possible to efficiently use the bandwidth when transferring content, even in a network in which not only ICN nodes but also IP routers are arranged.

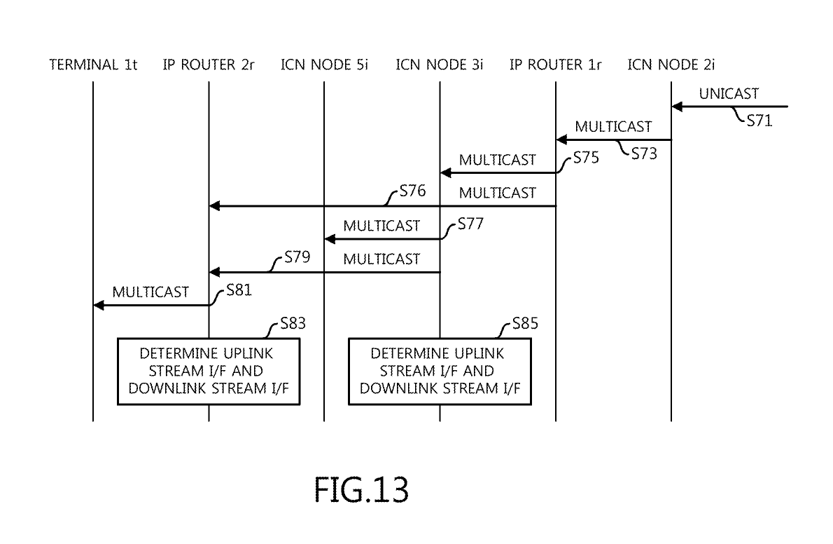

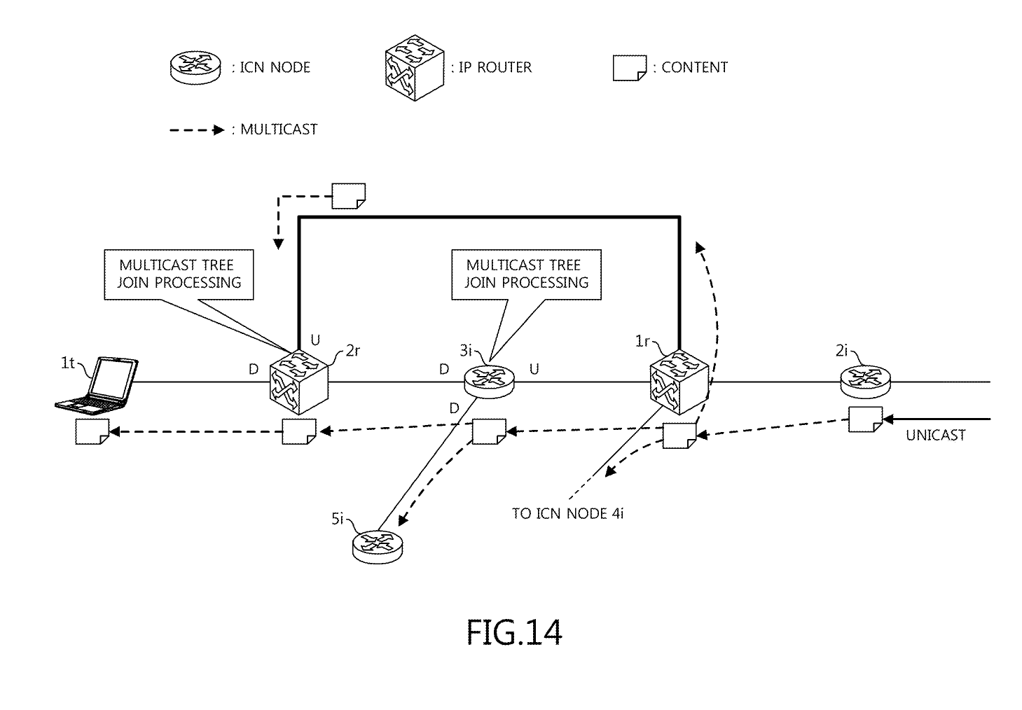

The multicast tree join processing will be explained with reference to FIGS. 13 to 18. Here, as represented by a thick line in FIG. 14, it is assumed that another route that is not illustrated in FIG. 8 to FIG. 10 exists between the IP router 1r and the IP router 2r.

First, the processing of RPF (Reverse Path Forwarding) will be explained with reference to FIGS. 13 and 14. The content transfer unit 10013 of the ICN node 2i receives content transmitted by unicast (FIG. 13: step S71) and stores a cache of the received content in the memory 100. Then, the content transfer unit 10013 of the ICN node 2i transfers the received content by multicast through interfaces other than an interface that received the content (that is, the interface for transmitting data to the IP router 1r) (step S73).

The IP router 1r receives the content transmitted by multicast. Then, the IP router 1r transfers the content by multicast through interfaces other than the interface that received the content (steps S75 and S76). As a result, as illustrated in FIG. 14, the content is transferred to the ICN node 3i, the IP router 2r and the ICN node 4i.

The content transfer unit 10013 of the ICN node 3i receives the content transmitted by multicast and stores a cache of the received content in the memory 100. Then, the ICN node 3i transfers the content by multicast through interfaces other than the interface that received the content (steps S77 and S79). As a result, as illustrated in FIG. 14, the content is transferred to the ICN node 5i and the IP router 2r.

The IP router 2r receives the content transmitted by multicast. Then, the IP router 2r transfers the content by multicast through interfaces other than the interface that received the content (step S81). As a result, as illustrated in FIG. 14, the content is transferred to terminal 1t.

Here, the IP router 2r determines an uplink stream interface and a downlink stream interface (step S83). In the example of FIG. 14, a face of the route with “U” corresponds to the uplink stream interface and a face of the route with “D” corresponds to the downlink stream interface. The IP router 2r sets the interface that received the content as the uplink stream interface and sets the interface that transmitted the content as the downlink stream interface. However, when content is received from plural interfaces, the IP router 2r sets one of the interfaces as the uplink stream interface. In the example of FIG. 14, the interface from the IP router 1r is set as the uplink stream interface.

Similarly, the multicast management unit 10015 of the ICN node 3i determines the uplink stream interface and the downlink stream interface as illustrated in FIG. 14 (step S85).

After the RPF processing, according to designation of a network administrator, the processing in the case of PIM-SM or the processing in the case of PIM-DM is executed.

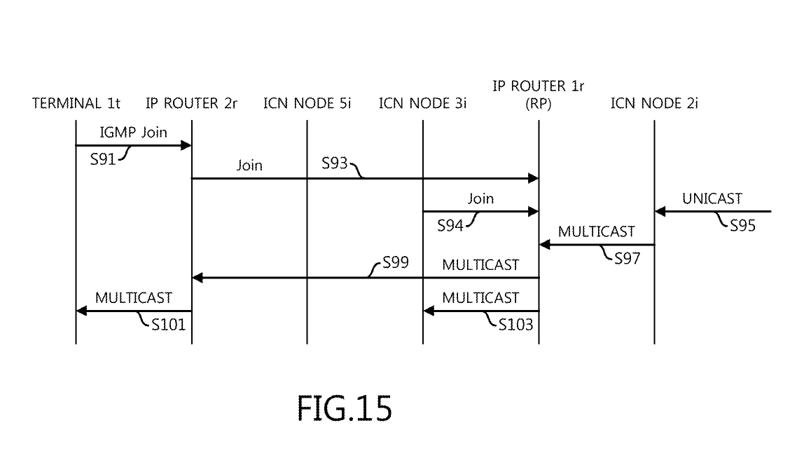

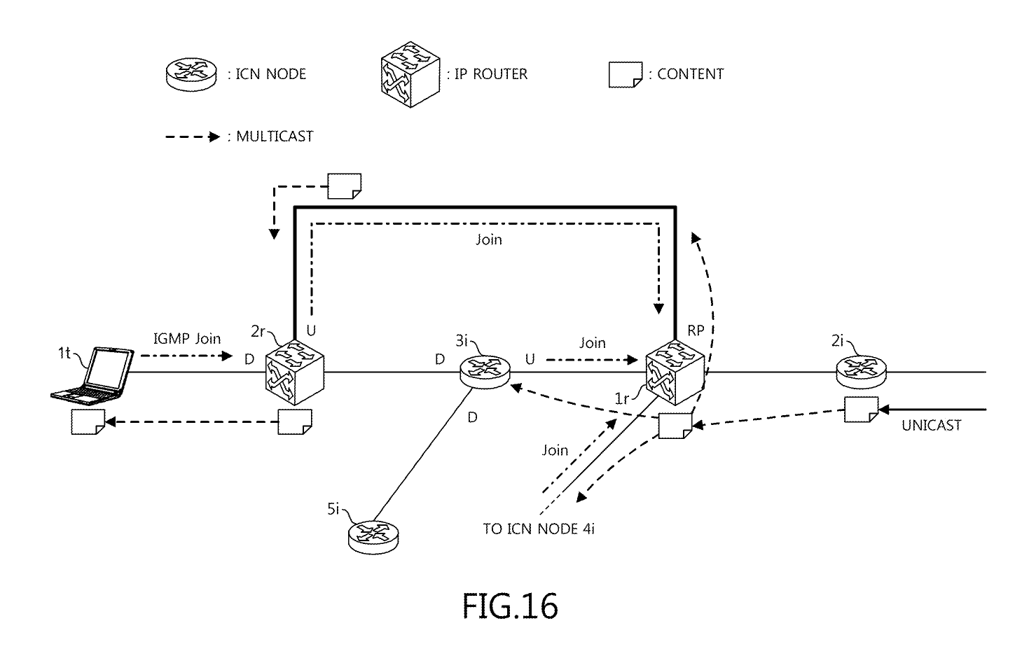

With reference to FIGS. 15 and 16, the processing of PIM-SM will be explained. Here, it is assumed that each terminal and each ICN node have already received correspondence relationship data.

The multicast management unit 20015 of the terminal 1t transmits, to the IP router 2r, an IGMP join message that includes a multicast address included in the correspondence relationship data stored in the memory 200 (FIG. 15: step S91).

When the IP router 2r receives the IGMP Join message from the terminal 1t, the IP router 2r transmits, through the uplink stream interface, a Join message to the IP router 1r that is a rendezvous point (step S93).

The multicast management unit 10015 of the ICN node 3i transmits, through the uplink stream interface, a Join message that includes the multicast address included in the correspondence relationship data stored in the memory 200 to the IP router 1r that is the rendezvous point (step S94). Although there is no terminal that requests the content under the ICN node 3i, since the ICN node 3i itself needs to cache the content, the ICN node 3i transmits a Join message to the IP router 1r.

The content transfer unit 10013 of the ICN node 2i receives the content transmitted by unicast (step S95), and stores a cache of the content in the memory 100. Then, the content transfer unit 10013 of the ICN node 2i transfers the received content to the IP router 1r by multicast (step S97).

The IP router 1r receives the Join messages from the IP router 2r and the ICN node 3i. In addition, as illustrated in FIG. 16, the IP router 1r also receives a Join message from the ICN node 4i. The IP router 1r transfers the content through faces that received the Join messages but does not transfer the content through faces that did not receive the Join messages. Specifically, the IP router 1r transmits the content to the IP router 2r by multicast (step S99). Moreover, the IP router 1r transmits the content to the ICN node 3i by multicast (step S103). Furthermore, the IP router 1r transmits the content to the ICN node 4i by multicast.

The IP router 2r receives the content from the IP router 1r. Then, the IP router 2r transmits the received content to the terminal 1t by multicast (step S101).

In FIG. 16, although the ICN node 3i transmits a Join message to the IP router 1r, if it is not transmitted, it is impossible for the ICN node 3i to receive the content. In this case, the IP router 1r does not transfer the content to the ICN node 3i, the content addressed to the IP router 2r does not pass through the ICN node 3i, and the IP router 1r transfers the content on a route represented by the thick line. Under the ICN node 3i, there is no terminal that requests the content, but since the ICN node 3i itself have to cache the content, the ICN node 3i sends a Join message to the IP router 1r.

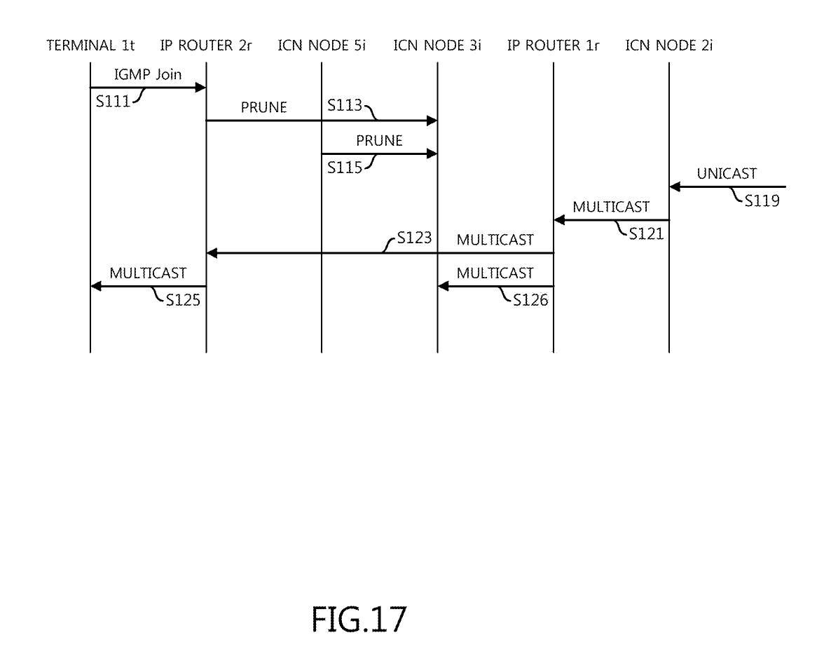

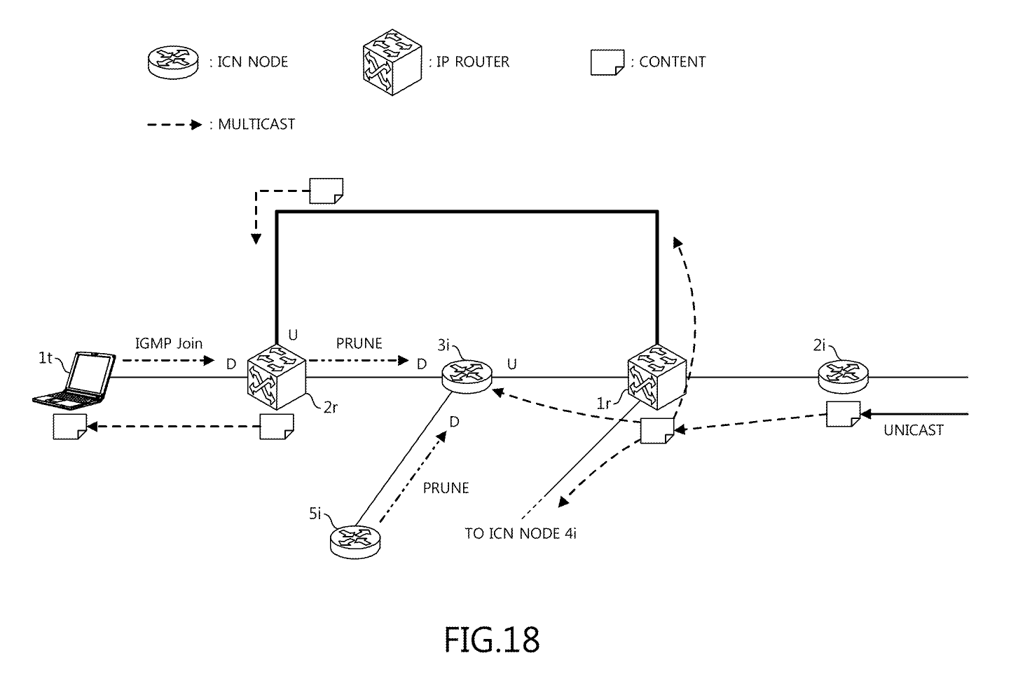

With reference to FIGS. 17 and 18, processing in the case of PIM-DM will be explained. Here, it is assumed that each terminal and each ICN node have already received correspondence relationship data.

The multicast management unit 20015 of the terminal 1t transmits, to the IP router 2r, an IGMP Join message that includes the multicast address included in the correspondence relationship data stored in the memory 200 (FIG. 17: step S111).

The IP router 2r transmits an IGMP prune message through a face which is not the downlink stream interface and the uplink stream interface (in this case, the face for transferring the data to the ICN node 3i) (step S113). The prune message is a message representing refusal to receive data by multicast.

The multicast management unit 10015 of the ICN node 5i transmits an IGMP prune message through a face which is not the downlink stream interface and the uplink stream interface (in this case, a face for transferring data to the ICN node 3i) (step S115).

When the ICN node 3i receives the prune messages from the two downlink stream interfaces of the ICN node 3i and the ICN node 3i does not have to join the multicast tree, the ICN node 3i transmits a prune message through the uplink stream interface to the IP router 1r. In this way, the IP router 1r does not deliver the content to the ICN node 3i.

Under the ICN node 3i, there is no terminal that requests the content, but since the ICN node 3i itself needs to cache the content, the ICN node 3i does not transmit the prune message in FIG. 17.

The content transfer unit 10013 of the ICN node 2i receives the content transmitted by unicast (step S119), and stores a cache of the content in the memory 100. Then, the content transfer unit 10013 of the ICN node 2i transfers the received content to the IP router 1r by multicast (step S121).

The IP router 1r receives the content transmitted by multicast from the ICN node 2i. Then, the IP router 1r transmits the content to the IP router 2r by multicast (step S123). In addition, the IP router 1r transmits the content to the ICN node 3i by multicast (step S126). Furthermore, the IP router 1r transmits the content to the ICN node 4i by multicast.

The IP router 2r receives the content from the IP router 1r. Then, the IP router 2r transmits the received content to the terminal 1t by multicast (step S125).

In FIG. 18, although the ICN node 3i does not transmit the prune message to the IP router 1r, if it is transmitted, it is impossible for the ICN node 3i to receive the content. In this case, the IP router 1r does not transfer the content to the ICN node 3i, the content addressed to the IP router 2r does not pass through the ICN node 3i, and the IP router 1r transfers the content on a route represented by the thick line. Although there is no terminal that requests the content under the ICN node 3i, since the ICN node 3i itself needs to cache the content, the ICN node 3i prevents transmission of the prune message to the IP router 1r.

In this embodiment, aggregation of interest packets is a trigger for starting communication by multicast. Therefore, it is preferable that there is a sufficient time for the interest packets to be aggregated. A case where plural interest packets are issued at completely different timings and delivery of content is completed in a short time is not suitable for this embodiment. On the other hand, for example, a case where live broadcast of sports (namely, live delivery) is scheduled to start at a specific time and each terminal issues an interest packet so as not to be late for the specific time is suitable for this embodiment.

By the way, a method for determining a multicast address that corresponds to content in advance regardless of the situation of the aggregation of interest packets may be considered. However, in such a case, multicast addresses are unnecessarily secured, even in a situation in which interest packets are not aggregated and communication efficiency is not improved even when delivering by multicast. On the other hand, according to this embodiment, a multicast address is secured in a situation where multicast delivery causes communication efficiency to be improved.

### Embodiment 2

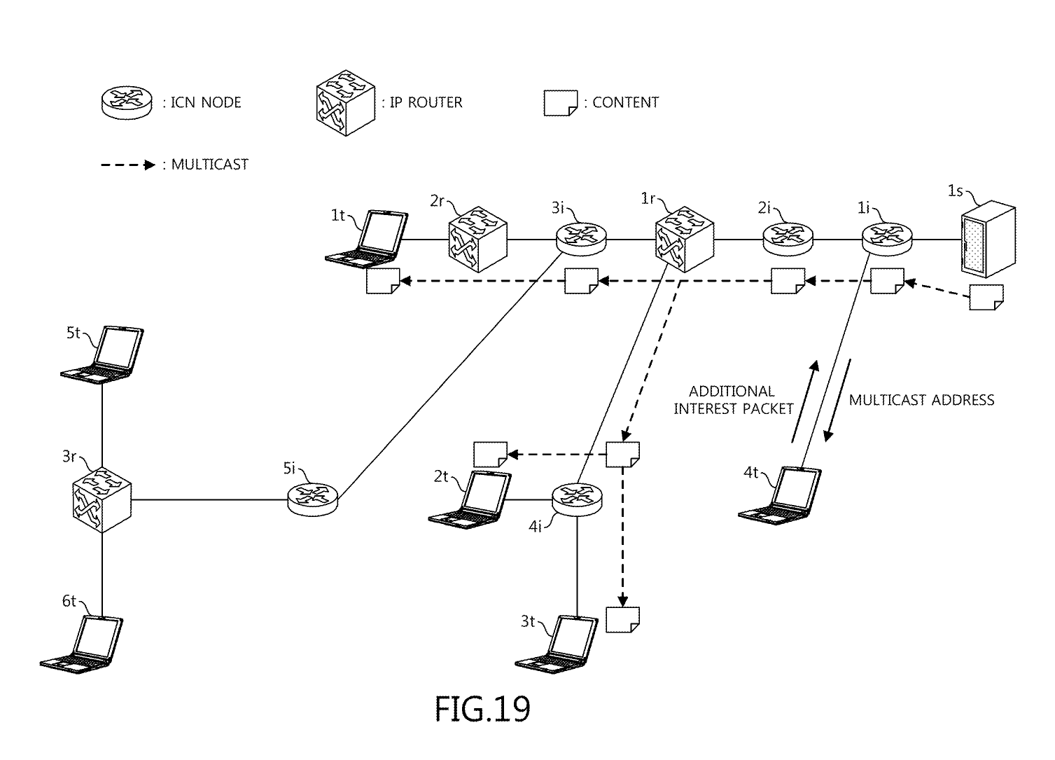

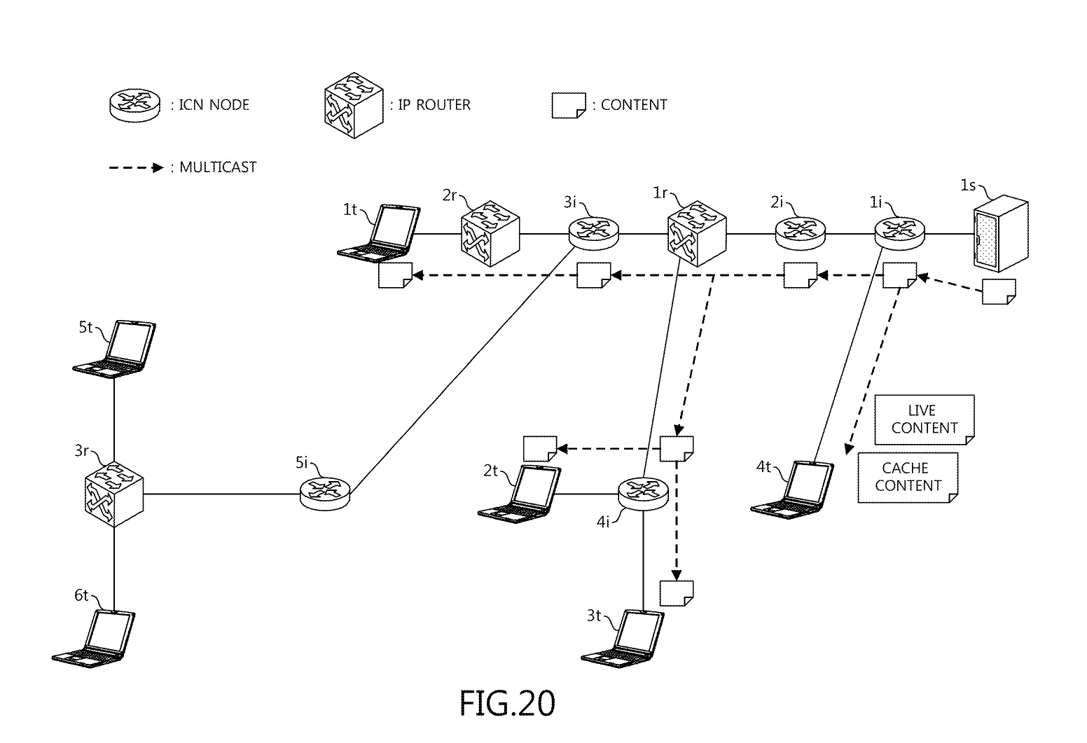

An overview of a second embodiment will be explained with reference to FIGS. 19 and 20. For example, as illustrated in FIG. 19, it is assumed that after live delivery of content to the terminals 1t to 3t started, the terminal 4t transmitted an interest packet (hereinafter referred to as an additional interest packet) that includes a content ID of the same content to the ICN node 1i. In this case, the ICN node 1i transmits correspondence relationship data that includes the content ID and a multicast address allocated to the content to the terminal 4t. In response to this, the terminal 4t executes the multicast tree join processing with respect to the multicast address included in the received correspondence relationship data. Specifically, as in the first embodiment, the terminal 4t transmits an IGMP Join message to the ICN node 1i.

Then, as illustrated in FIG. 20, it becomes possible for not only the terminals 1t to 3t but also the terminal 4t to receive the content. In addition to live data of the content, a cache of the content (that is, past delivery data) is delivered from the ICN node 1i to the terminal 4t, and it becomes possible to perform chasing playback at the terminal 4t.

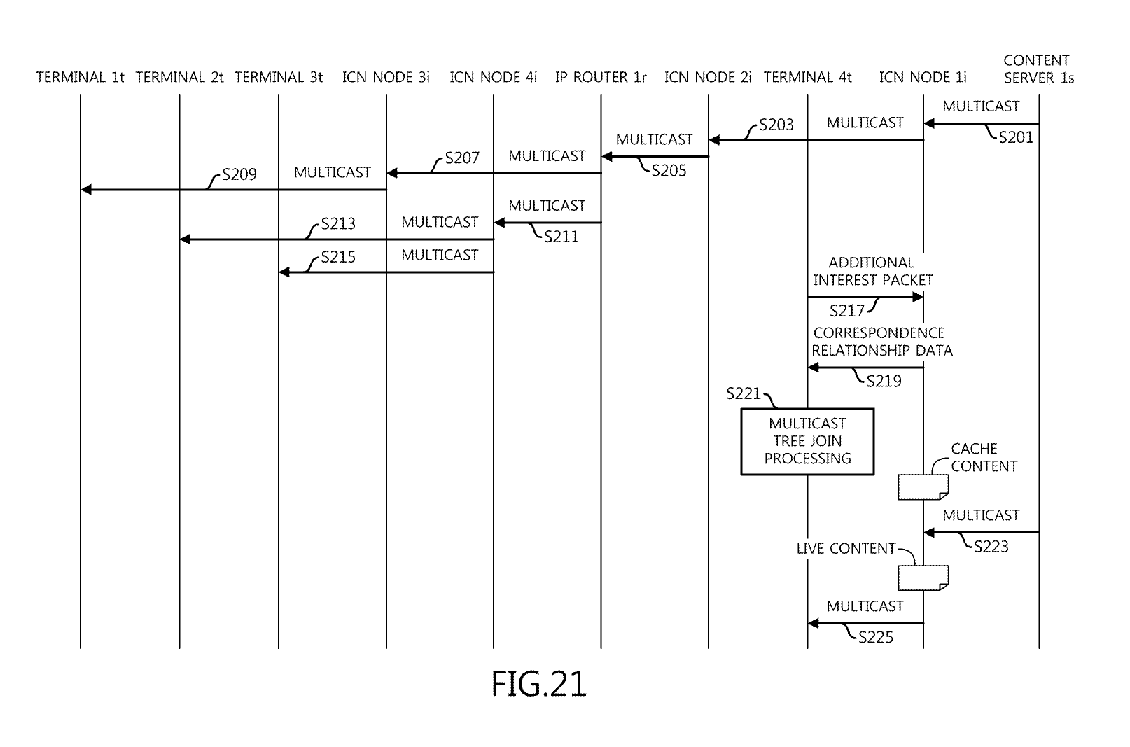

Next, with reference to FIG. 21, the second embodiment will be explained in more detail. It is assumed that delivery of content has already been performed due by execution of the processing in the first embodiment.

The content server 1s transmits content to the ICN node 1i by multicast (FIG. 21: step S201).

The content transfer unit 10013 of the ICN node 1i receives the content from the content server 1s and stores a cache of the received content in the memory 100. Then, the content transfer unit 10013 transmits the received content to the ICN node 2i by multicast (namely, by using the multicast transfer unit 10017) (step S203).

The content transfer unit 10013 of the ICN node 2i receives the content from the ICN node 1i and stores a cache of the received content in the memory 100. Then, the content transfer unit 10013 transmits the received content to the IP router 1r by multicast (step S205).

The IP router 1r copies the content received from the ICN node 2i and transmits the content to the ICN node 3i and the ICN node 4i by multicast (steps S207 and S211).

The content transfer unit 10013 of the ICN node 3i receives the content from the IP router 1r and stores a cache of the received content in the memory 100. Then, the content transfer unit 10013 transfers the received content to the terminal 1t by multicast (step S209).

The content transfer unit 10013 of the ICN node 4i receives the content from the IP router 1r and stores a cache of the received content in the memory 100. Then, the content transfer unit 10013 transfers the received content to the terminal 2t and the terminal 3t by multicast (steps S213 and S215).

Thereafter, the interest management unit 20011 of the terminal 4t transmits an additional interest packet to the ICN node 1i (step S217).

In response to this, the correspondence relationship management unit 10014 of the ICN node 1i transmits, to the terminal 4t, correspondence relationship data that includes the content ID included in the additional interest packet and the multicast address allocated to the content (step S219).

The correspondence relationship management unit 20014 of the terminal 4t receives the correspondence relationship data and stores it in the memory 200. Then, the multicast management unit 20015 executes the multicast tree join processing based on the multicast address included in the received correspondence relationship data (step S221). Specifically, the multicast management unit 20015 sends an IGMP Join message to the ICN node 1i.

The content server 1s transmits live data of the content (hereinafter referred to as live content) to the ICN node 1i by multicast (step S223).

The content transfer unit 10013 of the ICN node 1i receives the live content from the content server 1s and stores a cache of the received live content in the memory 100. Then, the content transfer unit 10013 of the ICN node 1i transmits the received live content and the cache 10022 (that is, cache content) stored in the memory 100 to the terminal 4t by multicast (step S225). The terminal 4t may align the received cache content and live content in order based on information (for example, number or time information) included in the content, to playback the content in chronological order and playback with a faster speed.

By executing the aforementioned processing, it becomes possible to browse both the cache content and the live content at the terminal 4t.

### Embodiment 3

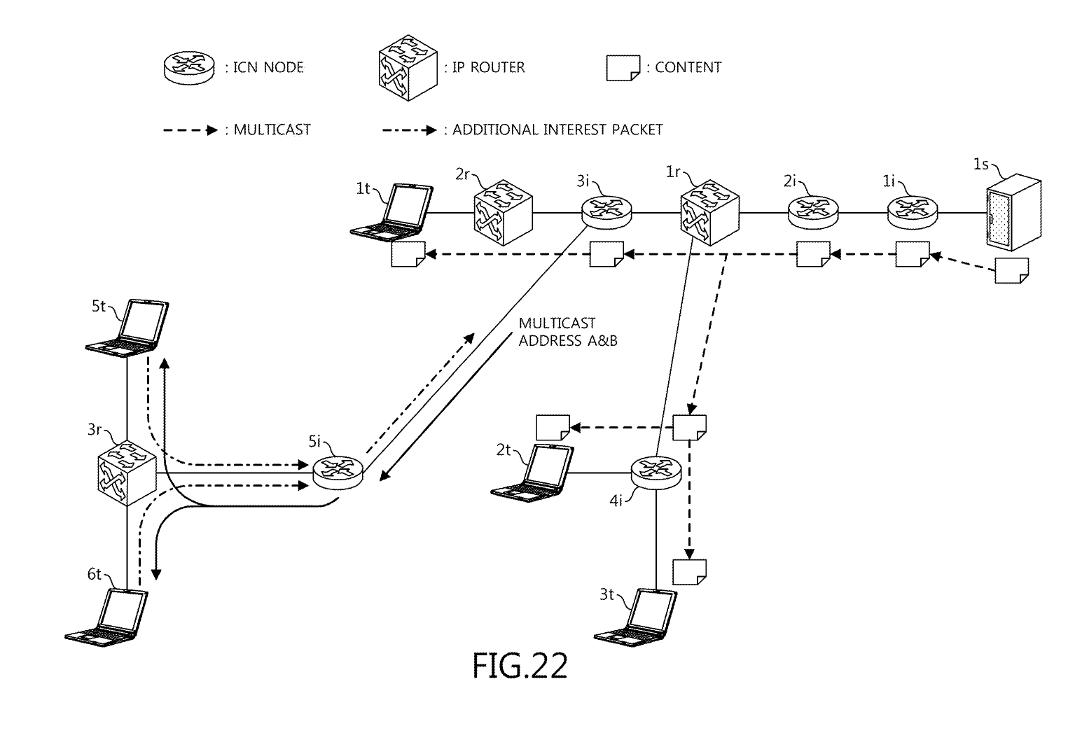

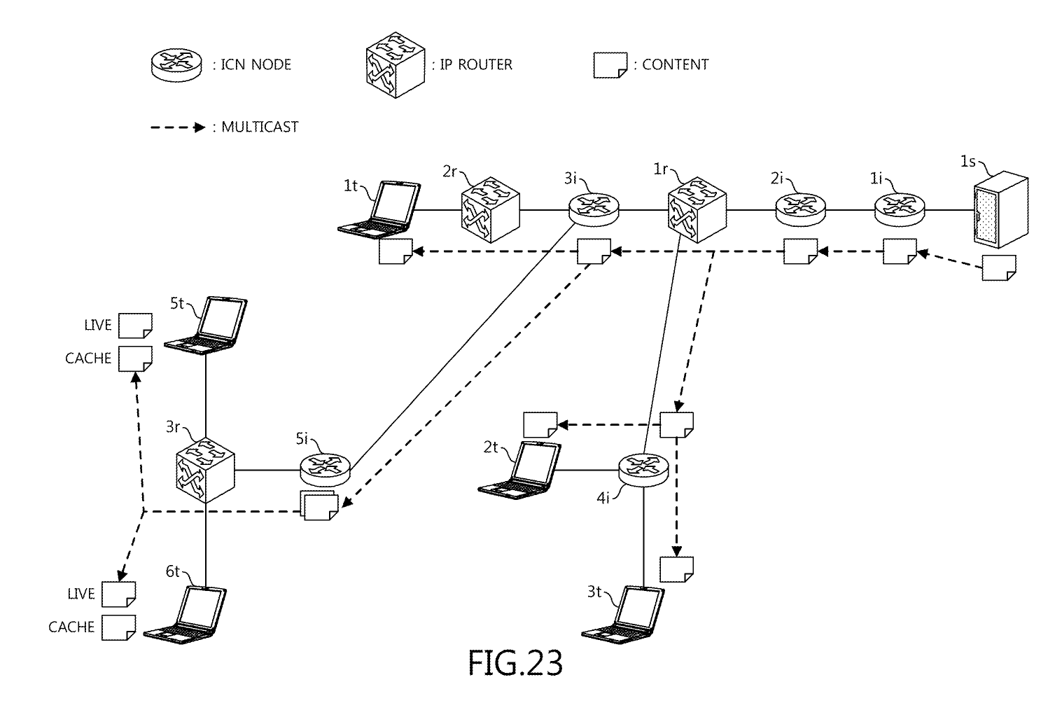

An overview of a third embodiment will be explained with reference to FIGS. 22 and 23. For example, as illustrated in FIG. 22, it is assumed that terminals 5t and 6t transmit additional interest packets to the ICN node 5i after live delivery of the content to the terminals 1t to 3t has started. In this case, the ICN node 5i aggregates the additional interest packets and transfers to the ICN node 3i. When the ICN node 3i receives the additional interest packet, the ICN node 3i transmits, to the ICN node 5i, correspondence relationship data that includes a content ID and a multicast address A allocated to the content. The correspondence relationship data is correspondence relationship data for live content. In addition, the ICN node 3i transmits, to the ICN node 5i, correspondence relationship data that includes the content ID and a multicast address B allocated to cache content. This correspondence relation data is correspondence relation data for the cache content. The ICN node 5i transmits the received correspondence relationship data to the terminals 5t and 6t. In response to this, the terminals 5t and 6t execute the multicast tree join processing with respect to the multicast address included in the received correspondence relationship data. Specifically, the terminals 5t and 6t transmit an IGMP Join message to the ICN node 5i with respect to the multicast address A to be allocated to the live content, and also transmit an IGMP Join message to the ICN node 5i with respect to the multicast address B to be allocated to the cache content. In addition, the ICN node 5i transmits a Join message to the ICN node 3i.

As a result, it is possible for not only the terminals 1t to 3t but also the terminals 5t and 6t to receive live content as illustrated in FIG. 23. Moreover, because not only live content but also cache content is delivered from the ICN node 3i to the terminals 5t and 6t, it becomes possible to perform chasing playback at the terminals 5t and 6t. Furthermore, by using a multicast address for live content and a multicast address for cache content properly, it becomes possible to prevent, in a network where redundant routes exist, transfer of cache content on a route that does not require cache content. As a result, wasteful consumption of bandwidth is to be prevented.

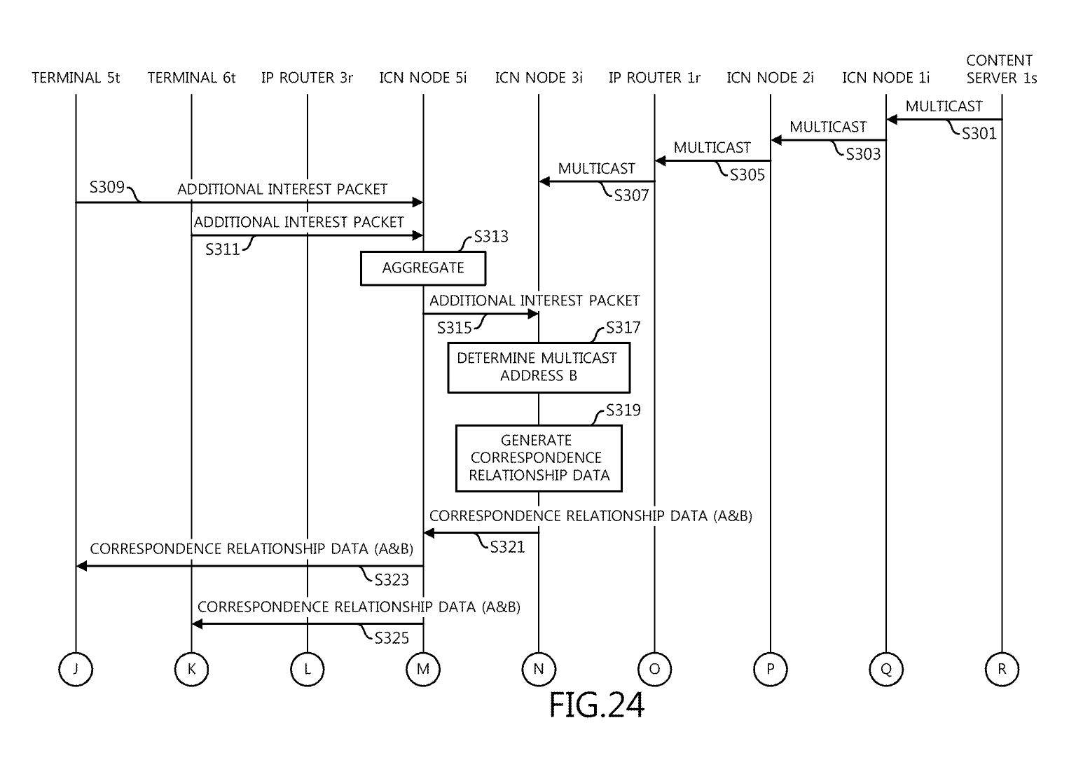

Next, the third embodiment will be explained in more detail with reference to FIGS. 24 to 26. It is assumed that delivery of content has already been performed using the multicast address A as a result of execution of the processing in the first embodiment.

The content server 1s transmits content to the ICN node 1i by multicast (FIG. 24: step S301).

The content transfer unit 10013 of the ICN node 1i receives the content from the content server 1s and stores a cache of the content in the memory 100. Then, the content transfer unit 10013 transmits the received content to the ICN node 2i by multicast (step S303).

The content transfer unit 10013 of the ICN node 2i receives the content from the ICN node 1i and stores a cache of the content in the memory 100. Then, the content transfer unit 10013 transmits the received content to the IP router 1r by multicast (step S305).

The IP router 1r transmits the content received from the ICN node 2i to the ICN node 3i by multicast (step S307).

Here, the interest management unit 20011 of the terminal 5t transmits the additional interest packet to the ICN node 5i (step S309), and the interest management unit 20011 of the terminal 6t transmits the additional interest packet to the ICN node 5i (step S311).

The interest management unit 10011 of the ICN node 5i aggregates the additional interest packet transmitted by the terminal 5t and the additional interest packet transmitted by the terminal 6t (step S313) and transfers one additional interest packet to the ICN node 3i (step S315).

The interest management unit 10011 of the ICN node 3i receives the additional interest packet. In response to this, the address determination unit 10012 determines a multicast address (in this case, the multicast address B) that corresponds to cache content (step S317). The correspondence relationship management unit 10014 generates correspondence relationship data that includes the content ID, information representing that it is the cache content and the multicast address B (step S319), and stores in memory 100. The correspondence relationship management unit 10014 transmits, to the ICN node 5i, the correspondence relationship data generated in step S319 and the correspondence relationship data that is stored in the memory 100 and includes the multicast address A (step S321).

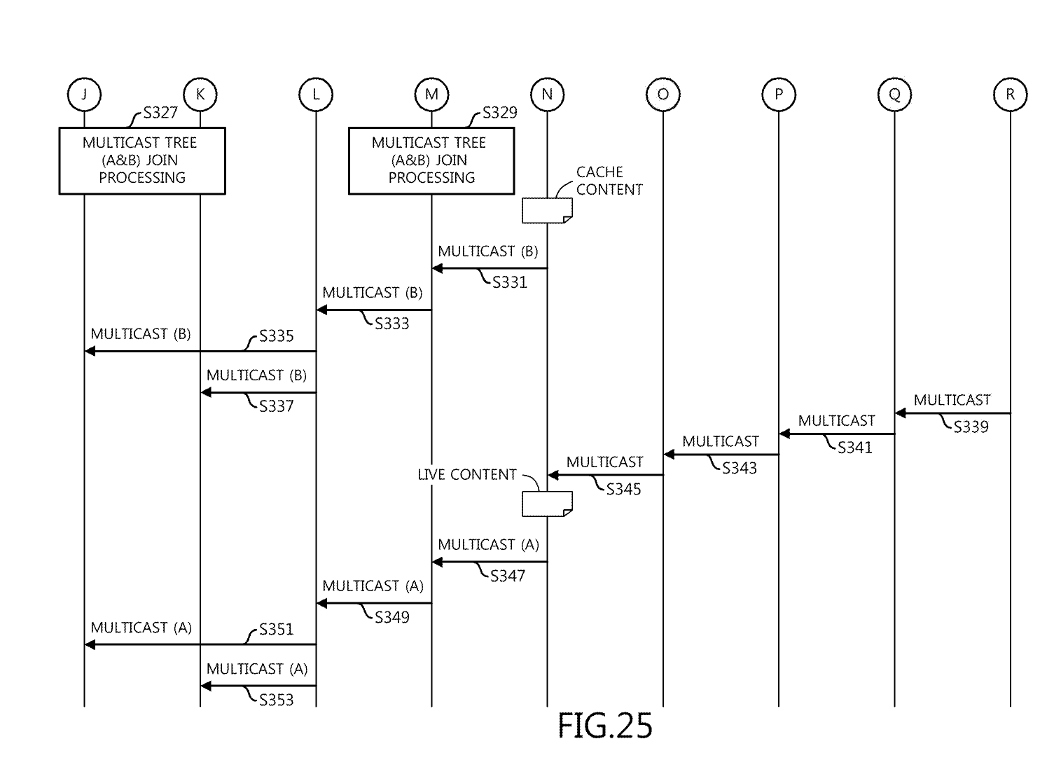

The correspondence relationship management unit 10014 of the ICN node 5i receives, from the ICN node 3i, the correspondence relationship data that includes the multicast address A and the correspondence relationship data that includes the multicast address B, and transfers to the terminal 5t (step S323). In addition, the correspondence relationship management unit 10014 transmits, to the terminal 6t, the correspondence relationship data that includes the multicast address A and the correspondence relationship data that includes the multicast address B (step S325), and stores in the memory 100. Then, the processing shifts to step S327 of FIG. 25 via terminals J to R.

Shifting to the explanation of FIG. 25, the multicast management unit 20015 of the terminal 5t and the multicast management unit 20015 of the terminal 6t execute the multicast tree join processing with respect to the multicast address A and the multicast address B (step S327). In addition, the multicast management unit 10015 of the ICN node 5i executes the multicast tree join processing with respect to the multicast address A and the multicast address B (step S329).

The content transfer unit 10013 of the ICN node 3i transmits, to the ICN node 5i, the cache 10022 (in other words, cache content) stored in the memory 100 of the ICN node 3i by multicast using the multicast address B (step S331).

The content transfer unit 10013 of the ICN node 5i receives the cache content from the ICN node 3i. Then, the content transfer unit 10013 of the ICN node 5i transmits the received cache content to the IP router 3r by multicast using the multicast address B (step S333).

The IP router 3r receives the cache content from the ICN node 5i. Then, the IP router 3r transmits the received cache content to the terminal 5t and the terminal 6t by multicast using the multicast address B (steps S335 and S337).

After that, the content server 1s transmits content to the ICN node 1i by multicast (step S339). The content transmitted in step S339 is live content.

The content transfer unit 10013 of the ICN node 1i receives the live content from content server 1s and stores a cache of the live content in memory 100. Then, the content transfer unit 10013 transmits the received live content to the ICN node 2i by multicast (step S341).

The content transfer unit 10013 of the ICN node 2i receives the live content from the ICN node 1i and stores a cache of the live content in the memory 100. Then, the content transfer unit 10013 transmits the received live content to the IP router 1r by multicast (step S343).

The IP router 1r transfers the live content received from the ICN node 2i to the ICN node 3i by multicast (step S345).

The content transfer unit 10013 of the ICN node 3i receives the live content from the IP router 1r and stores a cache of the live content in the memory 100. Then, the content transfer unit 10013 transmits the received live content to the ICN node 5i by multicast using the multicast address A (step S347).

The content transfer unit 10013 of the ICN node 5i receives the live content from the ICN node 3i and stores a cache of the live content in the memory 100. Then, the content transfer unit 10013 transmits the received live content to the IP router 3r by multicast using the multicast address A (step S349).

The IP router 3r receives the live content from the ICN node 5i. Then, the IP router 3r transmits the received live content to the terminal 5t and the terminal 6t by multicast using the multicast address A (steps S351 and S353). As well as the second embodiment, the terminal 5t and the terminal 6t may align the received cache content and live content in order based on information included in the content, to playback the content in chronological order and playback with a faster speed.

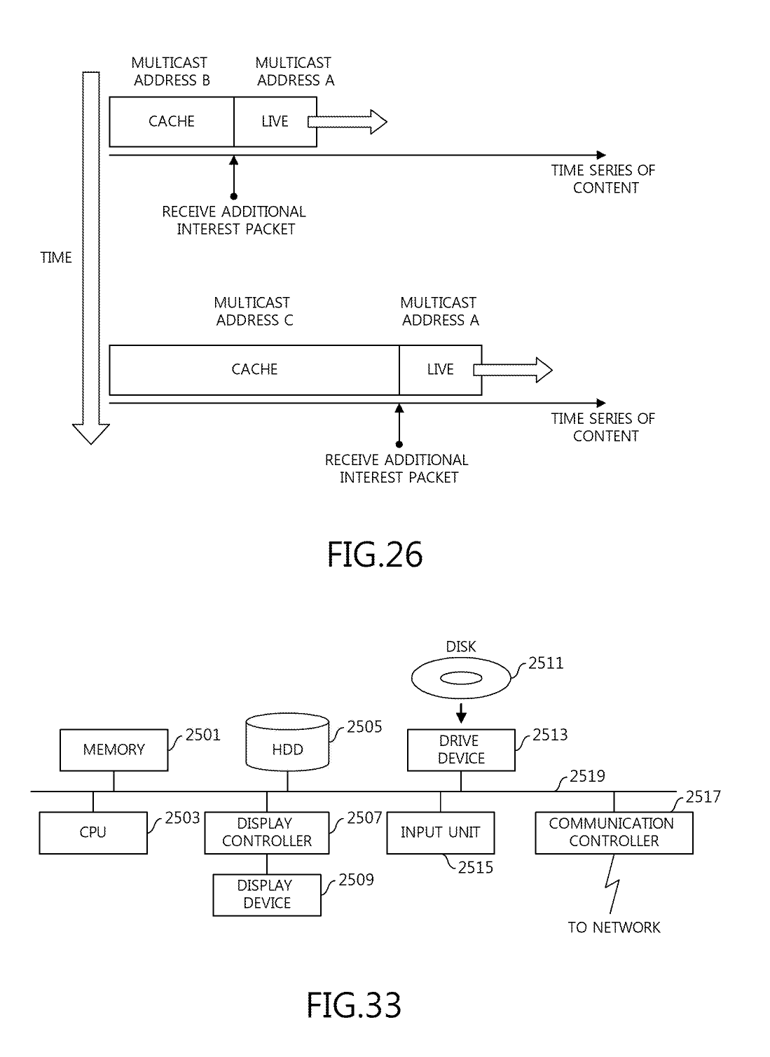

As illustrated in FIG. 26, it is assumed that another terminal (here, terminal 7t) transmits an additional interest packet to the ICN node 3i after delivery to the terminal 5t and the terminal 6t has started. In this case, a multicast address C different from the multicast address B is further determined with respect to delivery of the cache content to the terminal 7t, and the ICN node 3i performs multicast using the multicast address C for the terminal 7t.

As described above, by using a multicast address for live content and a multicast address for cache content, it becomes possible to prevent wasteful delivery of the cache content when the network is complicated.

### Embodiment 4

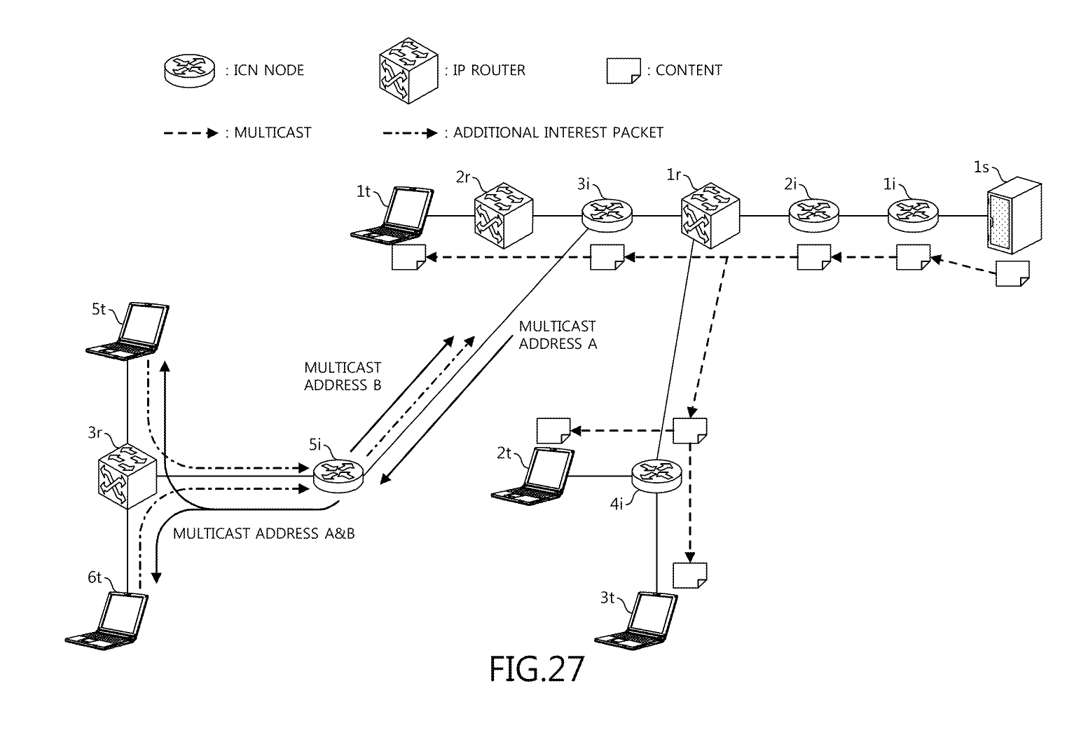

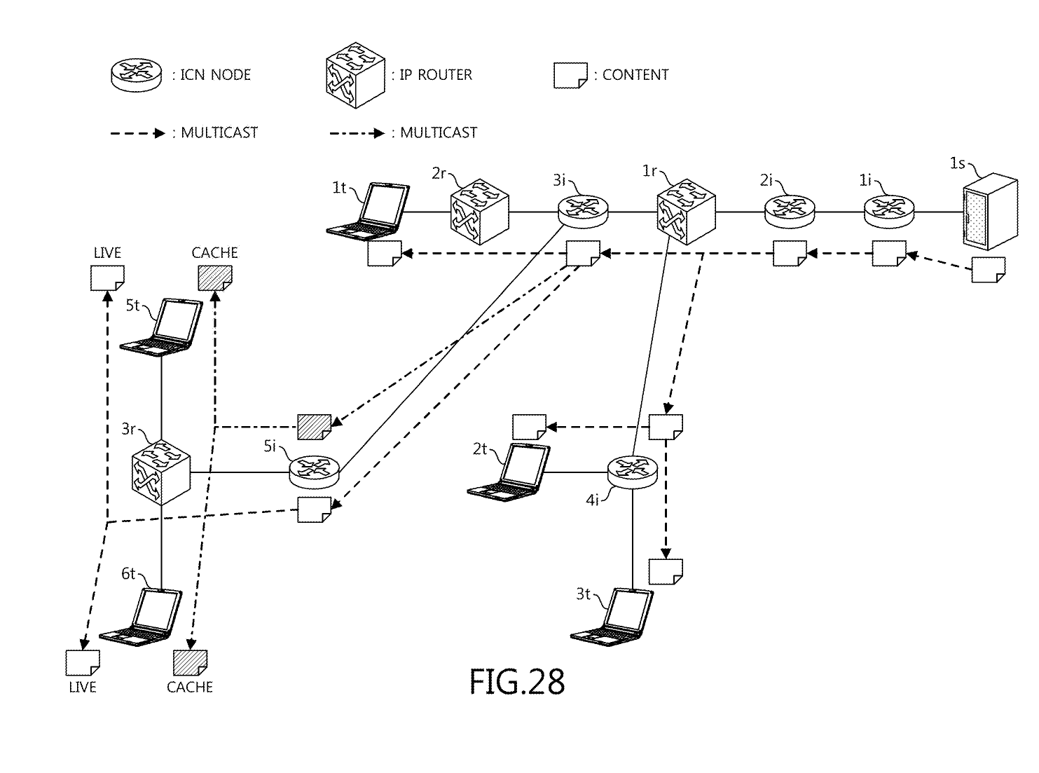

An overview of the fourth embodiment will be explained with reference to FIGS. 27 and 28. For example, as illustrated in FIG. 27, it is assumed that the terminals 5t and 6t transmit additional interest packets to the ICN node 5i after live broadcast of content to the terminals 1t to 3t has started. In this case, the ICN node 5i aggregates the additional interest packets and transfers to the ICN node 3i. When the ICN node 3i receives the additional interest packet, the ICN node 3i transmits correspondence relationship data that includes the content ID and the multicast address A allocated to the content to the ICN node 5i. Here, since the ICN node 3i is not an aggregate node for the cache content, the ICN node 3i does not determine a multicast address for the cache content but transmits the cache content to the ICN node 5i.

The ICN node 5i receives the correspondence relationship data that includes the multicast address A and the cache content. Since the ICN node 5i is an aggregate node for the cache content, the ICN node 5i determines the multicast address B to be allocated to the cache content. Then, the ICN node 5i generates correspondence relationship data that includes the content ID and the multicast address B. The ICN node 5i transmits the received correspondence relationship data and the generated correspondence relation data to the terminals 5t and 6t. In addition, the ICN node 5i transmits the generated correspondence relation data to the ICN node 3i. In response to this, the terminals 5t and 6t execute the multicast tree join processing with respect to the multicast address included in the correspondence relationship data. Specifically, the terminals 5t and 6t transmit an IGMP Join message to the ICN node 5i with respect to the multicast address A to be allocated to the live content, and also transmit an IGMP Join message to the ICN node 5i with respect to the multicast address B to be allocated to the cache content. In addition, the ICN node 5i transmits a Join message to the ICN node 3i.

As a result, as illustrated in FIG. 28, it becomes possible for not only the terminals 1t to 3t but also the terminals 5t and 6t to receive the live content. The following effects are obtained compared to the third embodiment. Namely, since multicast is not performed and forwarding is performed by unicast when there is no aggregate node for cache content, it becomes possible to prevent wasteful use of multicast addresses.

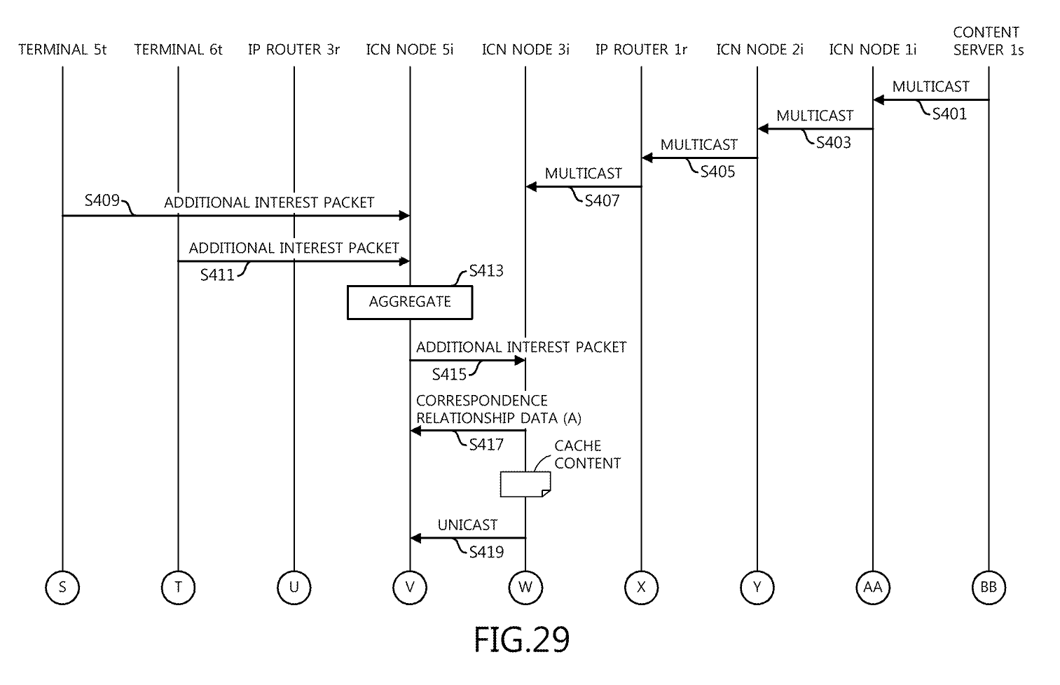

Next, the fourth embodiment will be explained in more detail with reference to FIGS. 29 to 31. It is assumed that delivery of content has already been performed using the multicast address A as a result of execution of the processing in the first embodiment.

The content server 1s transmits content to the ICN node 1i by multicast (FIG. 29: step S401).

The content transfer unit 10013 of the ICN node 1i receives the content from the content server 1s and stores a cache of the content in the memory 100. Then, the content transfer unit 10013 transmits the received content to the ICN node 2i by multicast (step S403).

The content transfer unit 10013 of the ICN node 2i receives the content from the ICN node 1i and stores a cache of the content in the memory 100. Then, the content transfer unit 10013 transmits the received content to the IP router 1r by multicast (step S405).

The IP router 1r transmits the content received from the ICN node 2i to the ICN node 3i by multicast (step S407).

Here, the interest management unit 20011 of the terminal 5t transmits an additional interest packet to the ICN node 5i (step S409), and the interest management unit 20011 of the terminal 6t transmits an additional interest packet to the ICN node 5i (step S411).

The interest management unit 10011 of the ICN node 5i aggregates the additional interest packet transmitted by the terminal 5t and the additional interest packet transmitted by the terminal 6t (step S413), and transfers one additional interest packet to the ICN node 3i (Step S415).

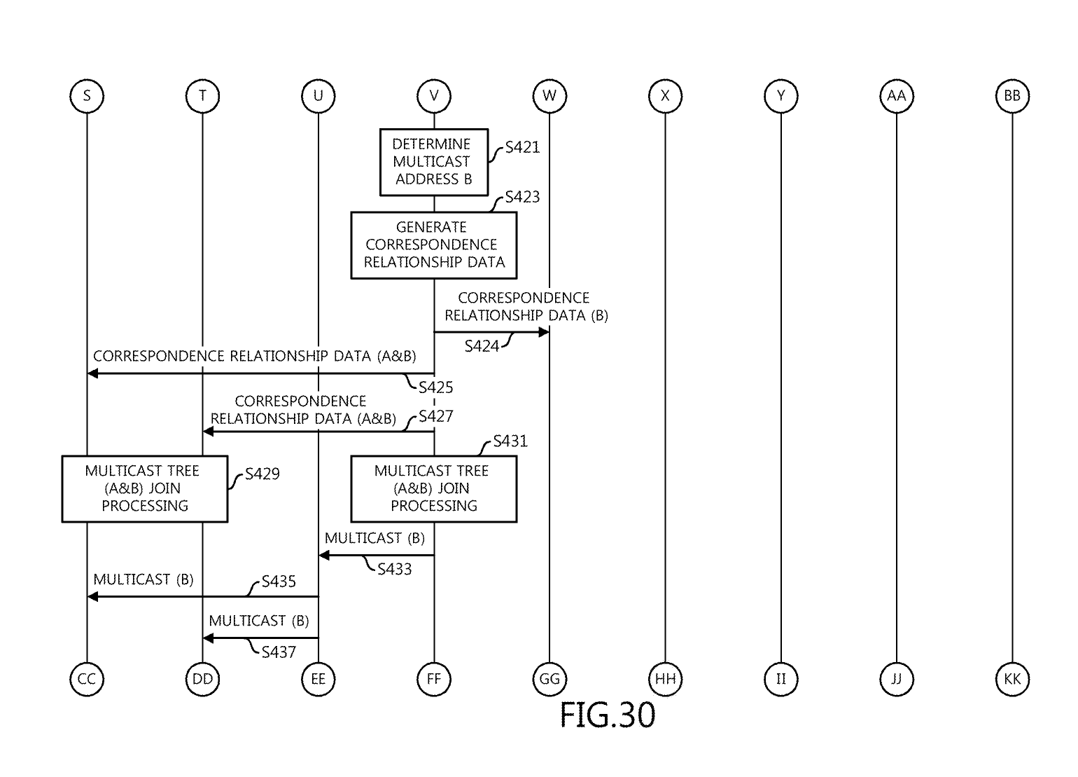

The interest management unit 10011 of the ICN node 3i receives the additional interest packet. The address determination unit 10012 does not determine the multicast address that corresponds to the cache content since the ICN node 3i is not an aggregate node for the cache content. Therefore, the correspondence relationship management unit 10014 transmits, to the ICN node 5i, correspondence relationship data stored in the memory 100 and includes the multicast address A (step S417). In addition, the content transfer unit 10013 transmits the cache content stored in the memory 100 to the ICN node 5i by unicast (step S419). The processing shifts to step S421 in FIG. 30 via terminals S to BB.

Shifting to the explanation of FIG. 30, the address determination unit 10012 of the ICN node 5i determines the multicast address B to be allocated to the cache content (step S421). The correspondence relationship management unit 10014 generates correspondence relationship data that includes the content ID, information representing that it is the cache content and the multicast address B (step S423), transmits to the ICN node 3i (step S424), and stores in the memory 100.

The correspondence relationship management unit 10014 of the ICN node 5i transmits, to the terminals 5t and 6t, correspondence relationship data that includes the multicast address A and correspondence relationship data that includes the multicast address B (steps S425 and S427).

The multicast management unit 20015 of the terminal 5t and the multicast management unit 20015 of the terminal 6t execute the multicast tree join processing with respect to the multicast address A and the multicast address B (step S429). In addition, the multicast management unit 10015 of the ICN node 5i executes the multicast tree join processing with respect to the multicast address A and the multicast address B (step S431).

The content transfer unit 10013 of the ICN node 5i transmits the cache content received from the ICN node 3i to the IP router 3r by multicast using the multicast address B (step S433).

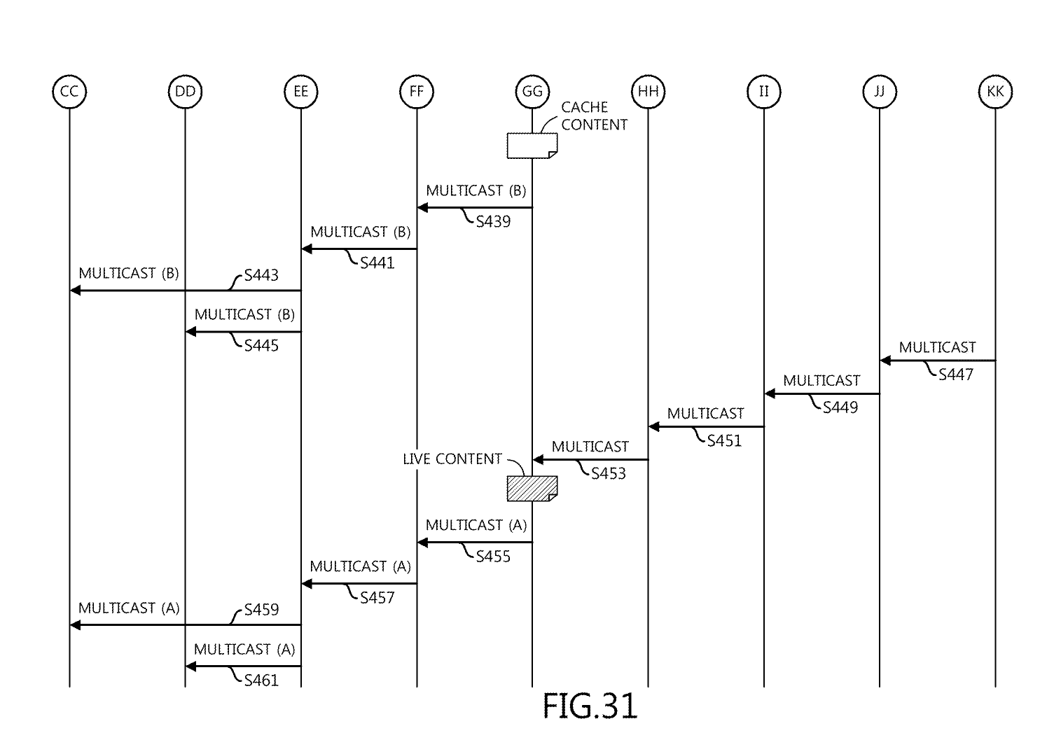

The IP router 3r receives the cache content from the ICN node 5i. Then, the IP router 3r transmits the received cache content to the terminal 5t and the terminal 6t by multicast using the multicast address B (steps S435 and S437). The processing shifts to step S439 of FIG. 31 via terminals CC to KK.

Shifting to the explanation of FIG. 31, the ICN node 3i transmits the cache content stored in the memory 100 to the ICN node 5i by multicast using the multicast address B (step S439). Similar processing is performed by unicast in step S419, but since there is a case where transmission of all the cache content is not completed only by the processing of step S419, the processing of step S439 is executed.

The content transfer unit 10013 of the ICN node 5i transmits the cache content received from the ICN node 3i to the IP router 3r by multicast using the multicast address B (step S441).

The IP router 3r receives the cache content from the ICN node 5i. Then, the IP router 3r transmits the received cache content to the terminal 5t and the terminal 6t by multicast using the multicast address B (steps S443 and S445).

After that, the content server 1s transmits content to the ICN node 1i by multicast (step S447). The content transmitted in step S447 is live content.

The content transfer unit 10013 of the ICN node 1i receives the live content from content server 1s and stores a cache of the live content in memory 100. Then, the content transfer unit 10013 transmits the received live content to the ICN node 2i by multicast (step S449).

The content transfer unit 10013 of the ICN node 2i receives the live content from the ICN node 1i and stores a cache of the live content in the memory 100. Then, the content transfer unit 10013 transmits the received live content to the IP router 1r by multicast (step S451).

The IP router 1r transfers the live content received from the ICN node 2i to the ICN node 3i by multicast (step S453).

The content transfer unit 10013 of the ICN node 3i receives the live content from the IP router 1r and stores a cache of the live content in the memory 100. Then, the content transfer unit 10013 transmits the received live content to the ICN node 5i by multicast using the multicast address A (step S455).

The content transfer unit 10013 of the ICN node 5i receives the live content from the ICN node 3i and stores a cache of the live content in the memory 100. Then, the content transfer unit 10013 transmits the received live content to the IP router 3r by multicast using the multicast address A (step S457).

The IP router 3r receives the live content from the ICN node 5i. Then, the IP router 3r transmits the received live content to the terminal 5t and the terminal 6t by multicast using the multicast address A (steps S459 and S461). As well as the second embodiment, the terminal 5t and the terminal 6t may align the received cache content and live content in order based on information included in the content, to playback the content in chronological order and playback with a faster speed.

As described above, use of a multicast address for live content and a multicast address for cache content enables to prevent wasteful delivery of the cache content when a network is complicated. In addition, since multicast is not performed and forwarding is performed by unicast when there is no aggregate node for cache content, it becomes possible to prevent wasteful use of multicast addresses.

Although the embodiments of this invention were explained above, this invention is not limited to those. For example, the functional block configuration of the ICN nodes and the terminals, which are explained above, does not always correspond to actual program module configuration.

Moreover, the aforementioned data configuration is a mere example, and may be changed. Furthermore, as for the processing flow, as long as the processing results do not change, the turns of the steps may be exchanged or the steps may be executed in parallel.

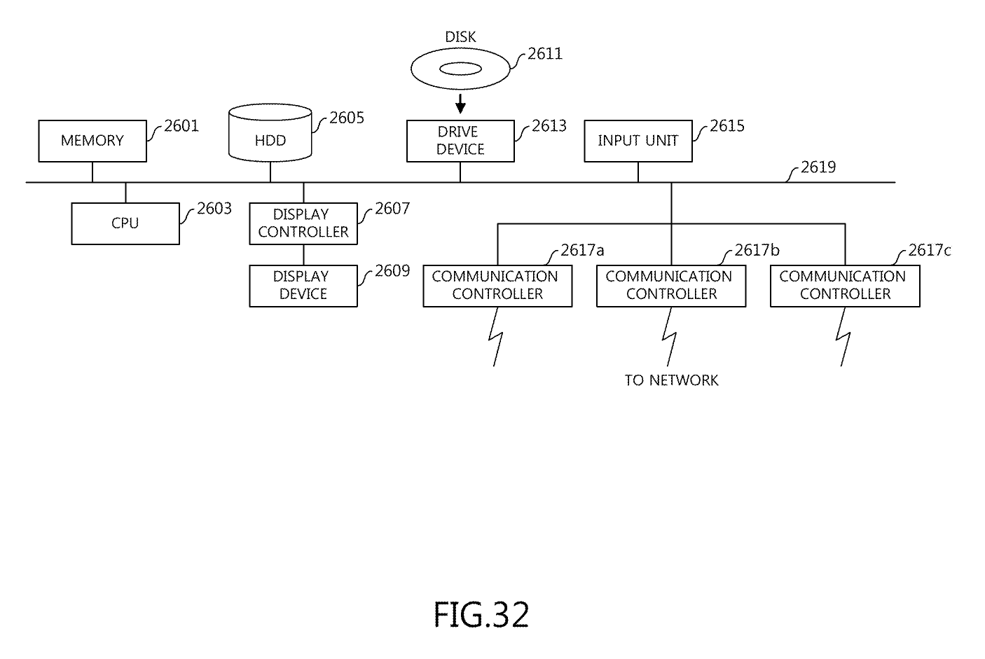

In addition, aforementioned IP router, as illustrated in FIG. 32, a memory 2601, CPU 2603, Hard Disk Drive (HDD) 2605, display controller 2607 to be coupled with a display device 2609, drive device 2613 for a removable disk 2611, input unit 2615 and communication controllers 2617 (2617a to 2617c in FIG. 32) for coupling to a network are coupled with a bus 2619. Incidentally, according to circumstances, the display controller 2607, display device 2609, drive device 2613 and input unit 2615 may not be included. An operating system (OS) and application programs for carrying out a processing in these embodiments are stored in the HDD 2605, and read out from the HDD 2605 to the memory 2601 when being executed by the CPU 2603. If necessary, the CPU 2603 controls the display controller 2607, communication controllers 2617 and drive device 2613 to carry out necessary operations. Incidentally, data that was inputted through any one of the communication controllers 2617 is outputted through another communication controller 2617. The CPU 2603 controls the communication controllers 2617 to appropriately switch output destinations. In addition, data during the processing is stored in the memory 2601, and stored in the HDD 2605 if necessary. In the embodiments of this technique, the application programs for carrying out the aforementioned processing are distributed by a computer-readable removable disk 2611 storing the application programs, and the application programs are installed into the HDD 2605 through the drive device 2613. The application programs may be installed into the HDD 2605 through the communication controllers 2617 and the network such as the Internet. Such a computer apparatus realizes the aforementioned various functions by cooperating the hardware such as the CPU 2603, memory 2601 and the like with the OS and the application programs if necessary.

In addition, the aforementioned terminals and content server are computer apparatuses as illustrated in FIG. 33. That is, a memory 2501, a CPU 2503 (central processing unit), a HDD (hard disk drive) 2505, a display controller 2507 connected to a display device 2509, a drive device 2513 for a removable disk 2511, an input unit 2515, and a communication controller 2517 for connection with a network are connected through a bus 2519 as illustrated in FIG. 33. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this invention, the application program to realize the aforementioned processing is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer apparatus as stated above, the hardware such as the CPU 2503 and the memory 2501, the OS and the application programs systematically cooperate with each other, so that various functions as described above in details are realized.

The aforementioned embodiments of this invention may be summarized as follows.

A communication apparatus relating to a first aspect of embodiments includes: a memory; and a processor coupled to the memory and configured to: transfer, to a first apparatus, one request packet of plural request packets for first content, upon receiving the plural request packets from a second apparatus; identify a first multicast address that is allocated to the first content; transmit, to the first apparatus and the second apparatus, identification information of the first content and the first multicast address; and transfer, to the second apparatus, the first content by the first multicast address, upon receiving the first content from the first apparatus.

Since it is possible to respond to plural request packets and transfer the content by multicast, bandwidth is not wastefully consumed, and it becomes possible to use the bandwidth efficiently.

Moreover, the processor may further be configured to: transmit, to a third apparatus, the identification information of the first content and the first multicast address, upon receiving a request packet for the first content from the third apparatus after transfer of the first content by the first multicast address has started; and transfer, to the third apparatus, a cache of the first content and live data of the first content by the first multicast address. It becomes possible for a user of the third apparatus to browse the first content delivered to the first apparatus in the past.

Moreover, the processor may further be configured to: identify a second multicast address that is allocated to a cache of the first content, upon receiving a request packet for the first content from a fourth apparatus after transfer of the first content by the first multicast address has started; transmit, to the fourth apparatus, first information that includes the identification information of the first content and the first multicast address, and second information that includes identification information of the cache of the first content and the second multicast address; transfer, to the fourth apparatus, the live data of the first content by the first multicast address; and transfer, to the fourth apparatus, the cache of the first content by the second multicast address. If the live data and the cache are transferred by the same multicast address, there is a possibility that the cache is transferred to a route for which the cache is not necessary. Therefore, by performing the aforementioned processing, it becomes possible to prevent wastefully transfer the cache and suppress consumption of bandwidth.

Moreover, the processor may further be configured to: identify a third multicast address that is allocated to a cache of the first content, upon receiving request packets for the first content from a fifth apparatus and a sixth apparatus after transfer of the first content by the first multicast address has started; transmit, to the fifth apparatus and the sixth apparatus, third information that includes the identification information of the first content and the first multicast address, and fourth information that includes identification information of the cache of the first content and the third multicast address; transfer, to the fifth apparatus and the sixth apparatus, the live data of the first content by the first multicast address; and transfer, to the fifth apparatus and the sixth apparatus, the cache of the first content by the third multicast address. It becomes possible for a multicast address to be determined when the communication apparatus corresponds to an aggregate node for a cache. This enables to suppress wasteful use of multicast addresses.

Moreover, the processor may further be configured to: perform processing to join a multicast group that corresponds to the first multicast address, upon receiving, from the second apparatus, a packet to request for joining the multicast group that corresponds to the first multicast address. It becomes possible to transfer content to the first apparatus by multicast.

Moreover, the processor may further be configured to: generate the first multicast address based on a hash function whose input is identification information of the communication apparatus and time information. It becomes possible to generate a multicast address in the communication apparatus.

Moreover, the communication apparatus may be a communication apparatus that performs ICN (Information Centric Networking) communication.

A communication method relating to a second aspect of the embodiments includes: transferring, to a first apparatus, one request packet of plural request packets for first content, upon receiving the plural request packets from a second apparatus; identifying a first multicast address that is allocated to the first content;

transmitting, to the first apparatus and the second apparatus, identification information of the first content and the first multicast address; and transferring, to the second apparatus, the first content by the first multicast address, upon receiving the first content from the first apparatus.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A communication apparatus, comprising:
a memory; and
a processor coupled to the memory and configured to:
transfer, to a first apparatus, one request packet of a plurality of request packets for first content, upon receiving the plurality of request packets from a second apparatus;
identify a first multicast address that is allocated to the first content;
transmit, to the first apparatus and the second apparatus, identification information of the first content and the first multicast address; and
transfer, to the second apparatus, the first content by the first multicast address, upon receiving the first content from the first apparatus.

2. The communication apparatus as set forth in claim 1, wherein the processor is further configured to:
transmit, to a third apparatus, the identification information of the first content and the first multicast address, upon receiving a request packet for the first content from the third apparatus after transfer of the first content by the first multicast address has started; and
transfer, to the third apparatus, a cache of the first content and live data of the first content by the first multicast address.

3. The communication apparatus as set forth in claim 1, wherein the processor is further configured to:
identify a second multicast address that is allocated to a cache of the first content, upon receiving a request packet for the first content from a fourth apparatus after transfer of the first content by the first multicast address has started;
transmit, to the fourth apparatus, first information that includes the identification information of the first content and the first multicast address, and second information that includes identification information of the cache of the first content and the second multicast address;
transfer, to the fourth apparatus, the live data of the first content by the first multicast address; and
transfer, to the fourth apparatus, the cache of the first content by the second multicast address.

4. The communication apparatus as set forth in claim 1, wherein the processor is further configured to:
identify a third multicast address that is allocated to a cache of the first content, upon receiving request packets for the first content from a fifth apparatus and a sixth apparatus after transfer of the first content by the first multicast address has started;
transmit, to the fifth apparatus and the sixth apparatus, third information that includes the identification information of the first content and the first multicast address, and fourth information that includes identification information of the cache of the first content and the third multicast address;
transfer, to the fifth apparatus and the sixth apparatus, the live data of the first content by the first multicast address; and
transfer, to the fifth apparatus and the sixth apparatus, the cache of the first content by the third multicast address.

5. The communication apparatus as set forth in claim 1, wherein the processor is further configured to:
perform processing to join a multicast group that corresponds to the first multicast address, upon receiving, from the second apparatus, a packet to request for joining the multicast group that corresponds to the first multicast address.

6. The communication apparatus as set forth in claim 1, wherein the processor is further configured to generate the first multicast address based on a hash function whose input is identification information of the communication apparatus and time information.

7. The communication apparatus as set forth in claim 1, wherein the communication apparatus is a communication apparatus that performs ICN (Information Centric Networking) communication.

8. A communication method, comprising:
transferring, by using a computer and to a first apparatus, one request packet of a plurality of request packets for first content, upon receiving the plurality of request packets from a second apparatus;
identifying, by using the computer, a first multicast address that is allocated to the first content;
transmitting, by using the computer and to the first apparatus and the second apparatus, identification information of the first content and the first multicast address; and
transferring, by using the computer and to the second apparatus, the first content by the first multicast address, upon receiving the first content from the first apparatus.

9. Anon-transitory computer-readable storage medium storing a program that causes a computer to execute a process, the process comprising:
transferring, to a first apparatus, one request packet of a plurality of request packets for first content, upon receiving the plurality of request packets from a second apparatus;
identifying a first multicast address that is allocated to the first content;
transmitting, to the first apparatus and the second apparatus, identification information of the first content and the first multicast address; and
transferring, to the second apparatus, the first content by the first multicast address, upon receiving the first content from the first apparatus.
